(19) United States
(12) Patent Application Publication
(10) Pub. No.: US 2026/0323419 A1
(43) Pub. Date: Oct. 15, 2026

(54) METHOD FOR TRANSMITTING HANDOVER COMMAND, CELL RESELECTION METHOD, DEVICE, AND COMPUTER DEVICE

(71) Applicant: Samsung Electronics Co., Ltd., Suwon-si, Gyeonggi-do (KR)

(72) Inventors: Fanhua KONG, Beijing (CN); Hong WANG, Beijing (CN); Lixiang XU, Beijing (CN); Weiwei WANG, Beijing (CN)

(21) Appl. No.: 18/998,854

(22) PCT Filed: Aug. 2, 2023
(86) PCT No.: PCT/KR2023/011364

§ 371 Date: Jan. 27, 2025

(30) Foreign Application Priority Data
Aug. 2, 2022 (CN) 202210923053.5

(51) Int. Cl. H04W 36/00; H04W 36/08

(52) U.S. Cl. CPC H04W 36/0072; H04W 36/087

(57) ABSTRACT

The present disclosure provides a method for transmitting a handover command, a cell reselection method, a device, and a computer device, relating to the field of communication technology. By transmitting first information to a user equipment (UE), the first information is configured to assist the source donor node in UE context handover; transmitting a handover command to the UE to achieve UE context handover from the source donor node to the target donor node. This enables the source donor node to perform the UE context handover with the assistance of the first information, which helps to avoid a sudden increase in signaling overhead via UU interface due to a large number of UE context handovers in a short period of time, helps to avoid problems such as interruption and retransmission of uplink data transmission caused by conflicts between uplink data transmission and UE context handover, improves UE communication service quality and enhances the user experience.

### CROSS-REFERENCE TO RELATED APPLICATION(S)

This application is a U.S. National Stage application under 35 U.S.C. §371 of an International application number PCT/KR 2023/011364, filed on Aug. 2, 2023, which is based on and claims priority of a Chinese patent application number 202210923053.5, filed on Aug. 2, 2022, in the Chinese Intellectual Property Office, the disclosure of which is incorporated by reference herein in its entirety.

### TECHNICAL FIELD

The present disclosure relates to the field of communication technology, and the present disclosure relates to a method for transmitting a handover command, a cell reselection method, a device, and a computer device.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

Wireless communication is one of the most successful innovations in modern history. Recently, the number of subscribers to wireless communications services exceeded 5 billion and continues to grow rapidly. The demand for wireless data services is growing rapidly due to the growing popularity of smartphones and other mobile data devices (e.g., tablet computers, laptop computers, netbooks, e-book readers and machine-type devices) among consumers and businesses. In order to meet rapid growth of mobile data services and support new applications and deployments, it is very important to improve efficiency and coverage of wireless interfaces.

### DISCLOSURE OF INVENTION

### Technical Problem

The present disclosure provides a method and device for transmitting/receiving a handover command efficiently, and for a cell reselection.

### Technical Solution

The present disclosure provides a method for transmitting a handover command, a cell reselection method, a device, and a computer device, the method for transmitting a handover command enables efficient context handover and improves the quality of UE communication services; by the cell reselection method provided in the present disclosure, the reselection to the wrong cell may be effectively avoided, and frequent cell selections by the UE due to failure of finding a suitable cell may be avoided. The provided technical solutions are as follows:

In one aspect, there is provided a method for transmitting a handover command, which is performed by a source donor node, the method includes:
transmitting first information to a user equipment (UE), the first information being configured to assist the source donor node in UE context handover;
transmitting a handover command to the UE.

Optionally, before transmitting a handover command to the UE, the method further includes;
receiving a first message transmitted by the UE based on the first information;
transmitting a handover command to the UE includes:
transmitting a handover command to the UE based on the first message.

Optionally, the first information includes at least one of the following items:
a first inquiry message, the first inquiry message being configured to inquire the UE for information relating to a time at which the UE expects context handover;
first indication information, the first indication information being configured to indicate information relating to at least one time period(s) for the context handover;
the first message includes at least one of the following items:
second information, the second information being configured to indicate information relating to a time at which the UE expects context handover;
third information, the third information being configured to indicate information relating to a target time period selected by the UE from the at least one time period(s).

Optionally, the first information includes a time at which the source donor node performs UE context handover.

Optionally, the method further includes:
receiving first assistance information transmitted by the UE based on the first information;
transmitting grouping information to the UE based on the first assistance information, the grouping information being configured to indicate a group which the UE belongs to;
transmitting a handover command to the UE includes:

transmitting second indication information to a corresponding group for which context handover is to be performed;
transmitting a handover command to the corresponding group for which context handover is to be performed,
wherein, the second indication information is configured to indicate that each UE included in the corresponding group receives the handover command.

Optionally, the first assistance information includes at least one of the following items:
the traffic period of the UE;
the time at which the UE expects context handover,
the time period during which the UE expects context handover.

Optionally, the second indication information includes at least one of the following items:
a notification message, the notification message being configured to notify each UE included in the corresponding group to perform context handover;
the time-frequency resource to be used by each UE included in the corresponding group to receive a handover command;
a group identifier of the corresponding group.

In another aspect, there is provided a method for transmitting a handover command, which is performed by a user equipment (UE), the method includes:
receiving first information transmitted by a source donor node, the first information being configured to assist the source donor node in UE context handover;
receiving a handover command transmitted by the source donor node.

Optionally, the method further includes:
transmitting a first message to the source donor node based on the first information;
receiving a handover command transmitted by the source donor node includes:
receiving a handover command transmitted by the source donor node based on the first message.

Optionally, the method further includes:
transmitting the first assistance information to the source donor node based on the first information;
receiving grouping information transmitted by the source donor node.

Optionally, the method further includes:
receiving second indication information transmitted by the source donor node;
receiving the handover command transmitted by the source donor node includes:
receiving, based on the second indication information, the handover command transmitted by the source donor node.

In yet another aspect, there is provided a method for transmitting a handover command, which is performed by a source donor node, the method includes:
transmitting first condition information or a handover command carrying first condition information to a user equipment (UE);
or,
transmitting a handover command carrying second condition information to a migrating node which the UE served by;
wherein, the first condition information is configured to indicate a condition to be satisfied for the UE to perform context handover, and the second condition information is configured to indicate a condition to be satisfied for the migrating node to transmit a handover command to the UE.

Optionally, the first condition information includes at least one of the following items:
a deadline threshold for the UE to perform context handover;
a time point or time interval at which the UE performs context handover;
receipt of a handover indication from a migrating node which the UE served by;
a change in a cell global identifier (NRCGI) of the migrating node which the UE served by;
a UE has no uplink or downlink traffic;
a UE is required to perform context handover;
completion of the last uplink or downlink traffic by a UE;
a UE has no uplink or downlink traffic in a first predefined time period.

Optionally, the second condition information includes at least one of the following items:
a deadline threshold for the UE to perform context handover;
a time point or time interval at which the UE performs context handover;
the migrating node at which the UE served by has a time frequency resource;
a reference signal received power RSRP value of the migrating node which the UE served by is not higher than a first threshold;
a change in a cell global identifier (NRCGI) of the migrating node which the UE served by;
a UE has no uplink or downlink traffic;
completion of the last uplink or downlink traffic by a UE;
a UE has no uplink or downlink traffic in a first predefined time period.

Optionally, the method further includes at least one of the following:
receiving third indication information transmitted by the UE;
receiving fourth indication information transmitted by the migrating node which the UE served by;
wherein, the third indication information is configured to indicate at least one of the following items: the UE satisfies the first condition information, the UE performs context handover, and an identifier of the UE which performing the context handover in case the first condition information is satisfied;
the fourth indication information is configured to indicate at least one of the following items: the migrating node satisfies the second condition information, the migrating node transmits a handover command to the UE, an identifier of the UE which performing the context handover in case the migrating node satisfies the second condition information.

Optionally, the method further includes:
receiving a first request transmitted by the UE in case the first condition information is satisfied, the first request being configured to request to perform context handover;
transmitting to the UE, in case of transmitting the first condition information to the UE, a handover command or a rejection of handover command based on the first request;
in case of transmitting a handover command carrying the first condition information to the UE, transmitting fifth indication information to the UE based on the first request, the fifth indication information being configured to indicate whether to activate the handover command.

On yet another aspect, there is provided a method for transmitting a handover command, which is performed by a user equipment (UE), the method includes:
receiving first condition information or a handover command carrying first condition information transmitted by a source donor node;
or,
receiving a handover command carrying second condition information transmitted by a migrating node which the UE served by;
wherein, the first condition information is configured to indicate a condition to be satisfied for the UE to perform context handover, and the second condition information is configured to indicate a condition to be satisfied for the migrating node to transmit a handover command to the UE.

Optionally, the method further includes any of the following items:
performing UE context handover from a source donor node to a target donor node, in case the first condition information is satisfied;
performing UE context handover from the source donor node to the target donor node based on a handover command transmitted by the migrating node.

Optionally, the method further includes:
transmitting a first request to the source donor node or the migrating node in case the first condition information is satisfied, the first request being configured to request to perform context handover;
wherein, when the first condition information transmitted by the source donor node is received, performing any of the following items:
receiving a handover command or a rejection of handover command transmitted by the source donor node;
receiving a handover command or a rejection of handover command transmitted by the migrating node;
wherein, when a handover command carrying first condition information transmitted by the source donor node is received, performing one of the following items:
receiving fifth indication information transmitted by the source donor node;
receiving fifth indication information transmitted by the migrating node;

In yet another aspect, there is provided a method for transmitting a handover command, which is performed by a migrating node which a user equipment (UE) served by, the method includes:
receiving a handover command carrying second condition information transmitted by a source donor node;
transmitting a handover command to the UE in case the migrating node satisfies the second condition information;
wherein, the second condition information is configured to indicate a condition to be satisfied for the migrating node to transmit a handover command to the UE

Optionally, the method further includes;
receiving a first request transmitted by the UE in case the first condition information is satisfied, the first request being configured to request to perform context handover;
transmitting a handover command or a rejection of handover command to the UE based on the first request in case of transmitting the first condition information to the UE.
transmitting fifth indication information to the UE based on the first request, in case of transmitting a handover command carrying the first condition information to the UE, the fifth indication information being configured to indicate whether to activate the handover command.

In yet another aspect, there is provided a cell reselection method, which is performed by a user equipment (UE), the method includes:
receiving a second message transmitted by a migrating node which the UE served by;
performing a cell reselection based on the second message, according to a first cell reselection criteria;
wherein, the UE camps on the first cell, and cells included in the migrating node include the first cell.

Optionally, when the frequency used by the first cell is with an equal priority to the priority of frequency used by a neighbor cell,
the first cell reselection criteria includes at least one of the following items:
the UE performs a cell reselection, if a difference between a reference signal received power RSRP value of the first cell and a maximum RSRP value of measured cells is higher than a second threshold;
the UE performs a cell reselection, if the RSRP value of the first cell in a first predetermined time measurement is less than the maximum RSRP value of the measured cells;
the UE performs a cell reselection, if the RSRP value of the first cell is less than a third threshold.

Optionally, when the frequency used by the first cell is with a priority higher than the priority of the frequency used by a neighbor cell,
the first cell reselection criteria includes at least one of the following items:
the UE performs a cell reselection, when the RSRP value of the first cell in a second predetermined time measurement is less than a fourth threshold and an RSRP value of a neighbor cell measured at a second predetermined time is greater than a fifth threshold;
the UE performs a cell reselection, when the RSRP value of the first cell is not less than a sixth threshold, or the RSRP value of the neighbor cell is not greater than a seventh threshold.

Optionally, when a frequency used by the first cell is with a priority lower than a priority of a frequency used by a neighbor cell;
the first cell reselection criteria includes:
the UE performing a cell reselection, when the RSRP value of the neighbor cell in a third predetermined time measurement is greater than an eighth threshold.

Optionally, the second message includes at least one of the following items:
sixth indication information, the sixth indication information being configured to indicate to perform a cell reselection according to the first cell reselection criteria;
seventh indication information, the seventh indication information being configured to indicate not according to the first cell reselection criteria;
eighth indication information, the eighth indication information being configured to indicate to perform a cell reselection according to a criteria specified in the first cell reselection criteria;
the first cell reselection criteria;
a first offset value;
a first priority.

Optionally, when the indication based on the second message is not according to the first cell reselection criteria, the method further includes:
performing a cell reselection based on a first priority included in the second message, and the second cell reselection criteria;
wherein the first priority indicates the priority of the frequency used by the first cell.

Optionally, when the indication based on the second message is not according to the first cell reselection criteria, the method further includes:
performing a cell reselection based on the first offset value included in the second message, and the second cell reselection criteria.
wherein the first offset value is configured to adjust a judgment threshold in the second cell reselection criteria.

Optionally, performing the cell reselection based on the second message, according to the first cell reselection criteria includes:
when the second message includes the sixth indication information, performing a cell reselection according to the first cell reselection criteria.
when the second message includes the seventh indication information or does not include sixth indication information or does not include eighth indication information, not according to the first cell reselection criteria.
when the second message includes the eighth indication information, performing a cell reselection according to a criteria specified in the first cell reselection criteria.

In yet another aspect, there is provided a source donor node device, the device includes:
a transceiver, configured for receiving and transmitting signals;
a controller, coupled to the transceiver and configured for performing the method for transmitting a handover command as described above.

In yet another aspect, there is provided a migrating node device which a user equipment (UE) served by includes:
a transceiver, configured for receiving and transmitting signals;
a controller, coupled to the transceiver and configured for performing the method for transmitting a handover command as described above.

In yet another aspect, there is provided a user equipment (UE), the UE includes:
a transceiver, configured for receiving and transmitting signals;
a controller, coupled to the transceiver and configured for performing a method for transmitting a handover command or a cell reselection method as described above.

In yet another aspect, there is provided a computer device including a memory, a processor and a computer program stored on the memory, the processor executing the computer program to implement the above-mentioned method for transmitting a handover command and the cell reselection method.

In yet another aspect, there is provided a computer-readable storage medium on which a computer program is stored, the computer program, when executed by a processor, implements the method for transmitting a handover command and the cell reselection method.

In yet another aspect, there is provided a computer program product comprising a computer program, the computer program, when executed by a processor, implements the method for transmitting a handover command and the cell reselection method.

In yet another aspect, there is provided a source donor node in a communication system, the source donor node comprises a transceiver, and a controller configured to transmit first information to a user equipment (UE) through the transceiver, the first information being configured to assist the source donor node in UE context handover, and transmit a handover command to the UE through the transceiver.

In yet another aspect, there is provided a user equipment (UE) in a communication system, the UE comprises a transceiver, and a controller configured to receive first information transmitted by a source donor node through the transceiver, the first information being configured to assist the source donor node in UE context handover, and receive, through the transceiver, a handover command transmitted by the source donor node.

The technical solutions provided by the embodiments of the present disclosure may bring the following beneficial effect:

The method for transmitting a handover command provided in the present disclosure may achieve UE context handover from the source donor node to the target donor node, by transmitting first information to a user equipment (UE), the first information being configured to assist the source donor node in UE context handover and transmitting a handover command to the UE. This enables the source donor node to perform the UE context handover with the assistance of the first information, which helps to avoid a sudden increase in signaling overhead via UU interface due to a large number of UE context handovers in a short period of time, helps to avoid problems such as interruption and retransmission of uplink data transmission caused by conflicts between uplink data transmission and UE context handover, improves UE communication service quality and enhances the user experience.

The present disclosure provides a method for transmitting a handover command, the method includes: transmitting first condition information or a handover command carrying the first condition information to a user equipment (UE), or, transmitting a handover command carrying second condition information to a migrating node which the UE served by; wherein the first condition information is configured to indicate a condition to be satisfied for the UE to perform context handover, and the second condition information is configured to indicate a condition to be satisfied for the migrating node to transmit a handover command to the UE. Based on the conditions, the UE is allowed to perform context handover, thus involving the conditions to control when or how the UE performs context handover, which enables effective control of context handover by the UE, therefore avoiding problems such as unable to perform context handover or delays due to sudden disconnection, and ensuring the reliability of UE context handover.

The cell reselection method provided in embodiments of the present disclosure, by obtaining the second message transmitted by the migrating node which the UE served by; performing the cell reselection based on the second message according to the first cell reselection criteria, may effectively avoid reselection to the wrong cell and avoid frequent cell selections by the UE due to cannot find a suitable cell.

### BRIEF DESCRIPTION OF DRAWINGS

In order to explain the technical solutions in the embodiments of the present disclosure more clearly, the accompanying drawings used in the description of the embodiments of the present disclosure will be briefly described below.

FIG. 1 is an exemplary system architecture 100 of system architecture evolution (SAE) provided by an embodiment of the present disclosure.

FIG. 2 is a schematic diagram of an exemplary system architecture 200 provided by an embodiment of the present disclosure.

FIG. 3 is a schematic diagram of a base station structure provided by an embodiment of the present disclosure.

FIG. 4 is a schematic diagram illustrating a UE context handover process provided by an embodiment of the present disclosure.

FIG. 5 is a schematic diagram illustrating a corresponding problem during UE context handover provided by an embodiment of the present disclosure.

FIG. 6 is a flow diagram of a method for transmitting a handover command provided by an embodiment of the present disclosure.

FIG. 7 is a schematic diagram illustrating a UE context handover sequence provided by an embodiment of the present disclosure.

FIG. 8 is as schematic diagram illustrating a process for context handover by group provided by an embodiment of the present disclosure.

FIG. 9 is a flow diagram illustrating a method for transmitting a handover command provided by an embodiment of the present disclosure.

FIG. 10 is a schematic diagram illustrating a process for transmitting a handover command carrying first condition information provided by an embodiment of the present disclosure.

FIG. 11 is a flow diagram illustrating a process for transmitting a handover command carrying second condition information provided by an embodiment of the present disclosure.

FIG. 12 is a schematic diagram illustrating context handover process including the process of transmitting a handover request by a UE provided by an embodiment of the present disclosure.

FIG. 13 is a schematic diagram illustrating the problem in a cell reselection process provided by an embodiment of the present disclosure.

FIG. 14 is a schematic flow diagram illustrating a cell reselection method provided by an embodiment of the present disclosure.

FIG. 15 is a schematic diagram illustrating a structure of a computer device provided by an embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

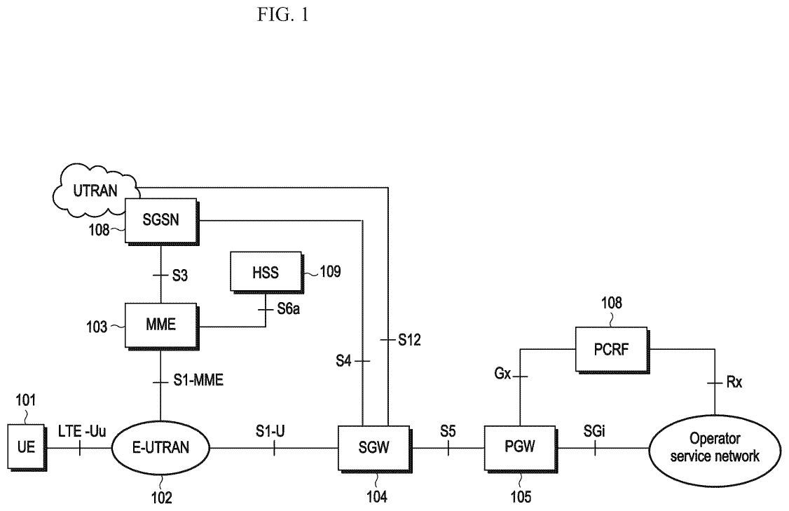

FIGS. 1 to 15 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

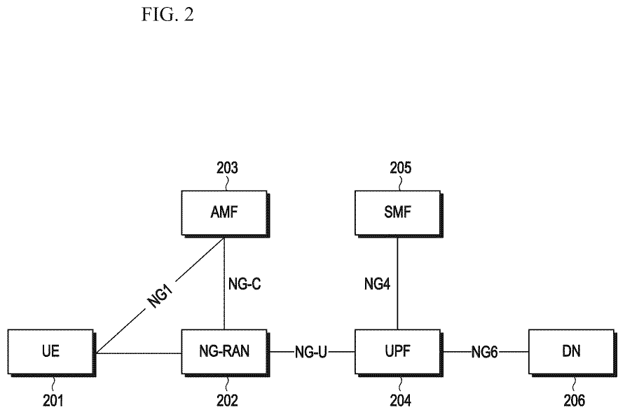

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

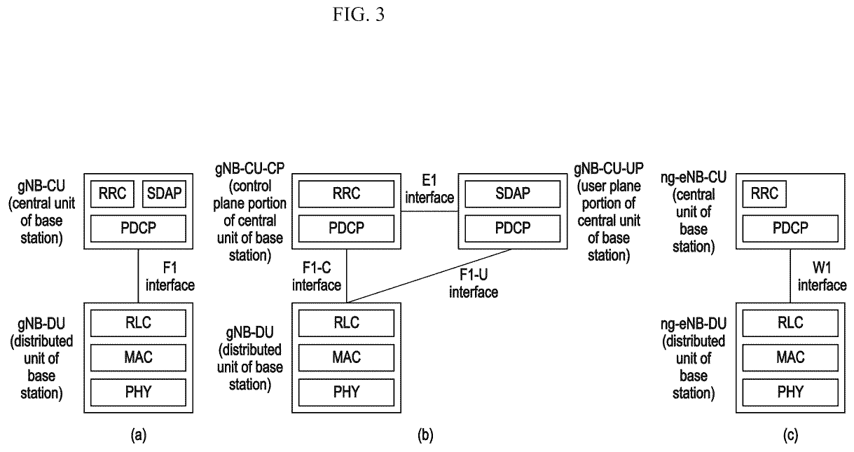

In the NR system, to support network function virtualization and more efficient resource management and scheduling, the base station (gNB/ng-eNB) that provides the wireless network interface for the terminal (UE) can be further divided into a central unit gNB-CU/ng-eNB-CU (gNB central unit/ng-eNB central unit) and a distributed unit gNB-DU/ng-eNB-DU (gNB distributed unit/ng-eNB distributed unit) (abbreviated as CU and DU in the present invention), as shown in FIG. 3(a). gNB-CU has Radio Resource Control (RRC), Service Data Adaptation Protocol (SDAP) and Packet Data Convergence Protocol (PDCP) protocol layers, etc. ng-eNB-CU has RRC, PDCP layers. gNB-DU/ng-eNB-DU has Radio Link Control Protocol (RLC), Media Access Control (MAC) and physical layers, etc. There is a standardized Public interface F1 between gNB-CU and gNB-DU, and there is a standardized public interface W1 between ng-eNB-CU and ng-eNB-DU. F1 interface is divided into control plane F1-C and user plane F1-U. The transport network layer of F1-C is based on IP transport. For more reliable signaling, the SCTP protocol is added on top of IP. The application layer protocol is FIAP, seeing 3GPP TS 38.473. SCTP can provide reliable application layer messaging transport. The transport layer of F1-U is UDP/IP, and GTP-U is used to carry user plane protocol data unit PDUs on top of UDP/IP. Further, for gNB-CU, as shown in FIG. 3(b), gNB-CU may include gNB-CU-CP (the control plane portion of the central unit of the base station) and gNB-CU-UP (the user plane portion of the central unit of the base station). gNB-CU-CP contains the functions of the control plane of the base station, and has RRC and PDCP protocol layers, and gNB-CU-UP contains the functions of the user plane of the base station, and has SDAP and PDCP protocol layers. There is a standardized public interface El between gNB-CU-CP and gNB-CU-UP, the protocol is E1AP, seeing 3GPP TS 38,463. The interface between the control plane portion of the central unit of the base station and the distributed unit of the base station is the F1-C interface, i.e., the control plane interface of F1, and the interface between the user plane portion of the central unit of the base station and the distributed unit of the base station is the F1-U interface, i.e., the user plane interface of F1. In addition, in the NR system, the base station providing E-UTRA user plane and control plane that is accessed to the 5G core network is called ng-eNB. To support virtualization, such base station (ng-eNB) can also be further divided into a central unit (ng-eNB-CU) (gNB central unit/ng-eNB central unit) and a distributed unit (ng-eNB-DU) (gNB distributed unit/ng-eNB distributed unit) (referred to as CU and DU in the present invention), as shown in FIG. 3(c). ng-eNB-CU has RRC, PDCP layers. gNB-DU/ng-eNB-DU has Radio Link Control Protocol (RLC), Medium Access Control (MAC) and physical layers, etc. There is a standardized public interface W1 Between ng-eNB-CU and ng-eNB-DU. The W1 interface is divided into control plane W1-C and user plane W1-U. The transport network layer of W1-C is based on IP transport. In order to transmit signaling more reliably, the SCTP protocol is added on top of IP. The protocol for the application layer is W1AP, seeing 3GPP TS 37.473. The transport layer of the W1-U is UDP/IP and GTP-U is configured to carry the user plane protocol data unit PDUs on top of UDP/IP.

In 5G communication technology, a transmission speed faster than 4G may be achieved by using higher frequencies; however, the higher frequencies will also lead to shorter transmission distance, therefore more base stations need to be deployed in the 5G network to ensure the coverage of the 5G network. However, in practice, some areas will not be able to carry out normal 5G base station deployment due to environmental or cost, so IAB (Integrated Access and Backhaul) technology is proposed to make up for the problem of 5G base stations not being able to cover these areas and ensure normal communication for users. But the existing IAB network technology is still inadequate, and only fixed and immobile IAB nodes are considered now. When mobile IAB nodes are supported in the future, the existing partial migration may not meet people's requirements for network performance, so a more in-depth study on IAB nodes with mobility attributes and full migration should be conducted.

At present, the IAB node (Integrated Access and Backhaul node) is considered to be fixed, so when the migrating node (that is, the migrating node which the UE served by) experiences a degradation in wireless performance, the source IAB donor CU (source IAB donor node central unit) may perform partial migration based on the measurement report reported by the migrating node, and migrate the RRC (Radio Resource Control) signaling part of the migrating node into the target path.

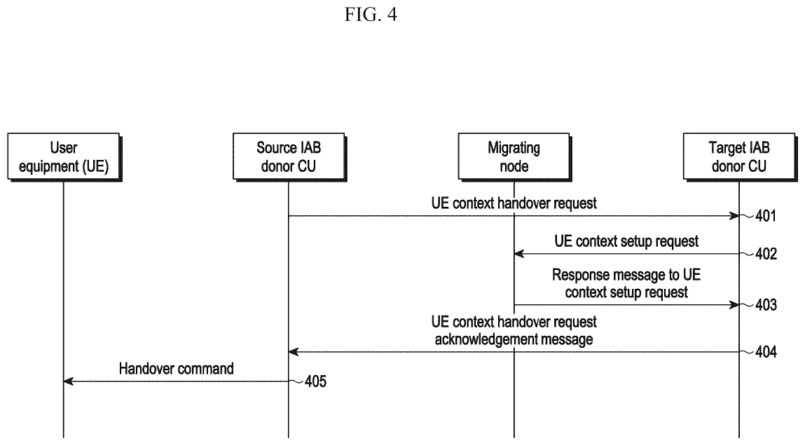

However, for mobile IAB nodes, sometimes only performing partial migration may not be sufficient; in some cases, full migration is required, i.e., the F1 connection need to be migrated into the target path as well, i.e., the F1 termination of the migrating node on the source IAB donor CU needs to be migrated to the target IAB donor CU (target IAB donor node central unit). When the F1 termination is migrated, the UE context on the migrating node is also required to be migrated, and the migration of the UE context is similar to the process of handover of the UE as shown in FIG. 4, with the following steps 401 to 405.

Step 401: the source IAB donor CU transmits a (UE context) handover request to the target IAB donor CU, the UE context handover request is configured to request the transfer of the UE context on the migrating node, the handover request includes configuration information of the UE configured by the source IAB donor CU.

Step 402: the target IAB donor CU transmits a UE context setup request to the migrating node.

Step 403: the migrating node replies to the target IAB donor CU with a UE context setup response, the response includes the configuration information of the UE configured by the migrating node.

Step 404: the target IAB donor CU replies to the source IAB donor CU with a UE context handover request acknowledgment message ((UE context) HO request ACK), which includes the configuration information of the UE configured by the migrating node.

Step 405: the source IAB donor CU transmits a handover command (HO Command) to the UE, the handover command may be transmitted via a UE context modification message. The UE modifies the UE context according to the received handover command, based on which, performs the UE context handover to the target IAB donor CU.

The migrating node and target IAB donor CU establish an F1-C connection before the handover of the UE context, the process needs further refinement.

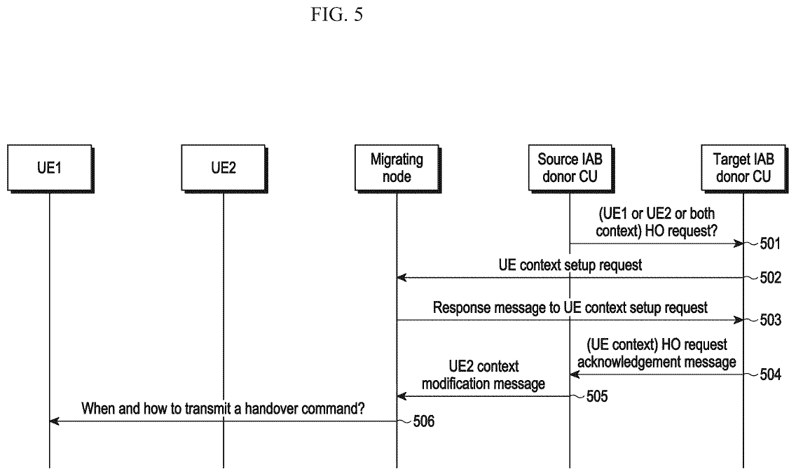

For example, the inventor of the present disclosure has further uncovered the following problems or requirements in the UE context handover process through their research, and the corresponding schematic diagram is shown in FIG. 5.

Step 501: the source IAB donor CU transmits a (UE context) handover request to the target IAB donor CU, the UE context handover request is associated with UE1 or UE2 or both context. Step 502: the target IAB donor CU transmits a UE context setup request to the migrating node. Step 503: the migrating node replies to the target IAB donor CU with a UE context setup response. Step 504: the target IAB donor CU replies to the source IAB donor CU with a UE context handover request acknowledgment message ((UE context) HO request ACK). Step 505: the source IAB donor CU transmits UE2 context modification message to the migrating node. Step 506: when and how to transmit a handover command (HO CMD) to UE1 is explored.

Question 1: Once an F1-C on a target path is established, if the UEs served by the migrating node need to transfer context separately, which UE does the source IAB donor CU need to transfer first?

Question 2: The present disclosure further proposes an idea of group UE context migration, that is, performing the context handover by group, and on this basis, the following questions are explored: is group UE context migration possible? and if so, how to perform group UE context migration?

Question 3. When the source IAB donor CU receives the HO request ACK from the target IAB donor CU, how to handle the UE context modification, i.e., when does the source IAB donor CU transmit the handover command to the UE? How to transmit to the UE?

Question 4: The present disclosure further proposes that the source IAB donor CU first transmits the UE context modification to the migrating node, and the migrating node decides how to transmit the HO CMD (i.e., handover command) to the UE; and on this basis, the following questions are explored in the step 506: How does the migrating node handle HO CMD, i.e., when does the migrating node transmit the HO CMD to the UE, and how does it transmit the HO CMD to the UE?

The above proposed problems are the technical problems to be solved by the present disclosure, which is described below with reference to the accompanying drawings.

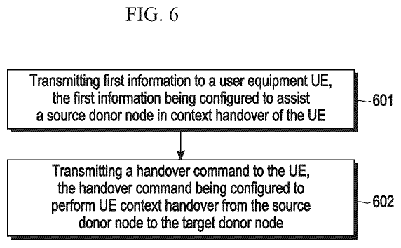

When there are multiple UEs for context handover, which UE is transferred first is implemented by the base station. However, in the study of the mobile migrating node, one special point is that when the migrating node which the UE served by performs a full migration, the context of each UE served by the migrating node which the UE served by needs to be transferred as well, this requires the base station to transfer the context of a large number of UEs in a short period of time, at this time the signaling overhead via UU interface will suddenly increase. In addition, if some UEs are performing uplink data transmission, such UEs will experience interruptions and retransmissions of uplink data due to context handover, and these interruptions and retransmissions will successively bring data delay problems, thus affecting user experience. Based on this, the present disclosure designs a method for transmitting a handover command to solve at least one of the above problems; the method is described below with reference to the flow shown in FIG. 6.

FIG. 6 is a schematic flow diagram of a method for transmitting a handover command provided by an embodiment of the present disclosure. The execution subject of the method may be a source donor node, for example, the execution subject may be a source IAB donor CU. As shown in FIG. 6, the method includes the following steps 60 to step 602.

Step 601: transmitting first information to the user equipment (UE), the first information being configured to assist the source donor node in UE context handover.

Step 602: transmitting a handover command to the UE, the handover command is configured to perform UE context handover from the source donor node to the target donor node.

Accordingly, the UE may perform the following steps:
receiving first information transmitted by the source donor node, the first information being configured to assist the source donor node in UE context handover.
receiving the handover command transmitted by the source donor node.

The source donor node may perform UE context handover based on the assistance of the first information. For example, the source donor node may transmit a handover command to the UE by transmitting the first information for the assistance of the source donor node to the UE.

In an alternative embodiment, the first information may be used by the source donor node to obtain information to be referred for transmitting the handover command to the UE. For example, the source donor node may obtain the first message transmitted by the UE based on the first system message to enable the source donor node to perform UE context handover based on the first message.

In a further alternative embodiment, the first information may be configured to inform the UE to assist the source donor node to perform UE context handover. For example, the source donor node may inform the UE of the time at which the source donor node is to perform UE context handover, such that the UE may receive the handover command transmitted by the source donor node at that time, e.g., the UE may perform the uplink data transmission at other times that avoiding the context handover time decided by the source donor node,

In a possible implementation environment, the UE is connected to the migrating node which the UE served by, and the migrating node which the UE served by may be a base station with mobility attributes; in some possible cases, the F1 termination of the migrating node which the UE served by in the source donor node needs to be migrated to the target donor node, the UE context on the migrating node which the UE served by also needs to be migrated from the source donor node to the target donor node. For example, in the in-vehicle scenario, the IAB node (called migrating node in the present disclosure) with mobility attributes may be installed on the train or car, and the UE may be the cell phone, tablet and other user equipment of the passengers on the train or car, and the migrating node and the UE also move during the train movement; if the signal between the migrating node and the source IAB donor CU is bad, the F1 termination of the migrating node may be migrated from the source IAB donor CU to the target IAB donor CU, at this time, the context of UE served by the migrating node also needs to be migrated; for example, by transmitting a handover command (HO Command) to the UE to migrate the UE context from the source IAB donor CU to the target IAB donor CU based on the handover command.

In one embodiment, the first information may be configured to assist the source donor node in obtaining a first message transmitted by the UE, and the source donor node may refer to the first message to handover the context of the UE. Before the step 602, the method may further includes: receiving the first message transmitted by the UE based on the first information. Accordingly, the step 602 is implemented in a manner includes: transmitting a handover command to the UE based on the first message. Accordingly, the UE may further perform the step of: transmitting a first message to the source donor node based on the first information. The step of the UE receiving the handover command transmitted by the source donor node may include: the UE receives the handover command transmitted by the source donor node based on the first message.

Exemplarily, the first information may include at least one of the following items:
a first inquiry message, the first inquiry message being configured to inquire the UE for information relating to a time at which the UE expects context handover;
first indication information, the first indication information being configured to indicate information relating to at least one time period(s) during which context handover is allowed.

Exemplarily, the first message includes at least one of the following items:
second information, the second information being configured to indicate information relating to a time at which the UE expects context handover;
third information, the third information being configured to indicate information relating to a target time period selected by the UE from the at least one time period(s) during which context handover is allowed.

For example, the source donor node may use the second information and/or the third information in the first message as a reference to transmit a handover command to the UE.

Exemplarily, the first information may be a SIB (system information block); e.g., SIB1, and the source donor node may add a first inquiry message and/or first indication information to SIB1, generate the first information, and transmit the first information to the UE. Alternatively, the first information may be an RRC message, e.g., the first information may be a first downlink message. For example, the first inquiry message may be configured to inquire the UE for the time point, the time period, etc. at which context handover is expected.

Exemplarily, the first message may be an RRC message, e.g., the first message may be a first uplink message. The RRC message may be a UAI (UE assistance information); for example, the UE may add second information and/or third information to the UAI of the uplink, generate the first message, and transmit the first message to the source donor node.

For example, the first inquiry information or the first indication information may be represented as Preferred HO Time; the second information or the third information is a reply to the first inquiry information or the first indication information, respectively, and the second information may be represented as Preferred HO Time ACK (Acknowledgement Message of Preferred HO Time); and the third information may be Preferred HO Time ACK IE (Information block of Acknowledgement Message of Preferred HO Time), Preferred HO Time ACK or the Preferred HO Time ACK IE may be added to the UAI.

In one possible implementation, if the first information transmitted by the source donor node to the UE includes a first inquiry message, the first message transmitted by the UE to the source donor node includes a second information. The second information includes the time at which the UE expects context handover, the time may be a time determined by the UE, for example, a time determined by the UE based on the traffic requirements of the UE's uplink data. The present disclosure does not limit the implementation of how the UE determines the time at which the UE expects to perform a context migration. In an example, the second information may include a start time at which the UE expects to perform the context handover, which may be a time deviation corresponding to a predetermined subframe in a predetermined frame of a predetermined superframe of the UE. The predetermined superframe, predetermined frame, predetermined subframe, etc. may be set based on demand, and the present disclosure does not limit this. For example, the second information includes the time offset (time deviation or time offset) from the 0#subframe (0^{th} subframe) in the 0#SFN (0^{th} frame) in the H-SFN (Hyper System Frame Number) which the UE receives the first information, that is, the starting time is the time deviation from the 0^{th} subframe in the 0^{th} frame in the hyper-frame which the UE receives the first information.

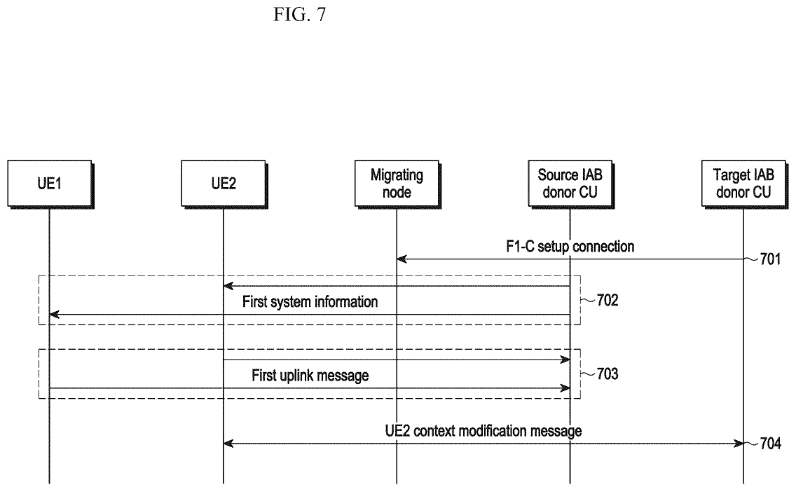

Exemplarily, a possible implementation is that the source IAB donor CU inquires the UE for the context migration time the UE expects, which is described below in the process shown in FIG. 7, which may include the steps of interactions between the source IAB donor CU, the migrating node, the UE, and the target IAB donor CU. As shown in FIG. 7, the method for transmitting a handover command may include the following steps 701 to step 704:
Step 701: an F1-C connection may be established between the migrating node and the target IAB donor CU.
Step 702: The source IAB donor CU may add a first inquiry message (Preferred HO Time1) in the SIB (e.g., in SIB1), generate first information, and transmit the first information to the UEs (UE1, UE2). The first inquiry message is configured to inquire the time the UE expects the UE context migration.

It should be noted that the execution order of the step 702 may be before or after the step 701, and the present disclosure does not limit the execution order of the step 702.
Step 703: the UE receives the first information and the UE may add second information, e.g., a reply information (Preferred HO Time ACK), to the uplink RRC message to generate a first message to provide feedback to the source IAB donor CU on the time when the UE expects context handover.

For example, the RRC message may be the UE assistance information UAI. For example, the time at which the UE expects context handover may be the time offset from the 0^{th} subframe in the 0^{th} SFN in the H-SFN which the UE receives the SIB.
Step 704: UE2 context modification message is exchanged between UE2 and the target IAB donor CU.
the source IAB donor CU determines the order of the individual UE context handover with reference to the time in the individual UE reply message.

In yet another possible implementation, if the first information includes a second inquiry message, the first message includes third information. The first indication information may include at least one time period(s) during which the UE is allowed to perform the context handover, and the third information may include a target time period selected by the UE from the at least one time period(s), wherein the target time period may include one or more time periods selected by the UE; the present disclosure is not limited in this regard. An embodiment of the source IAB donor CU providing context handover time period to the UE is provided below, differing from the embodiment shown in FIG. 7 in two ways:
Point 1: the source IAB donor CU adds the first indication information (Preferred HO Time2) to the SIB, generates the first information, and transmits the first information to the UE. The first indication information is configured to indicate the n time periods during which the UE may perform context handover without directly asking the UE for the desired time at which the context handover is expected.
Point 2: the UE selects one of the n time periods during which the context handover may be performed and adds it into the uplink RRC message (e.g., the Preferred HO Time ACK IE may be added to the UAI) to generate the first message. The source IAB donor CU may determine the time period during which each UE expects the context handover based on the first message returned by each UE.

In a further embodiment, the source donor node may provide the time of the context handover directly to each UE, without the second information or third information fed back by the UE. The first information includes the time at which the source donor node performs the UE context handover; the step 602 of FIG. 6 may then include: broadcasting to the UE the time at which the source donor node performs the UE context handover.

Exemplarily, the time at which the source donor node performs the UE context handover may include at least one time period(s) and/or at least one time point. In the present disclosure, there is no specific limitation on the time at which the source donor node performs the UE context handover.

The UE receives the time at which the source donor node performs the UE context handover and adjusts the arrangement of the UE for uplink data transmission according to the time at which the source donor node performs the UE context handover, e.g., the UE adjusts the time of the uplink data transmission to a time different from the time at which the source donor node performs the UE context handover; such that the time of the uplink data transmission by the UE may avoid the time of UE context handover, for example, the time of the UE performing uplink data transmission may be before or after the time of UE context handover; thus avoiding the impact of interruption and retransmission caused by context handover on uplink data transmission, and thus avoiding the problem of time delay and effectively improving user experience.

In this embodiment, the source IAB donor CU may provide the context handover time directly to all UEs, differing from the above implementation in the following two points:
Point 1: the source IAB donor CU adds the context handover time in the SIB message, generates the first information and broadcasts it to all UEs, and the UE may adjust the uplink data schedule (uplink data arrangement or uplink data scheduling) after receiving the first information, i.e., the UE will not perform the uplink data transmission at the corresponding context handover time.
Point 2: the UE may not need to reply to the source IAB donor CU with the second information or the third information, and the source IAB donor CU may not need to determine the context handover of individual UEs based on the second information or the third information. For example, the source IAB donor CU may determine the context handover order of individual UEs by means of an implementation, which may be configured based on demand, there is no limitation on that in the present disclosure.

It should be noted that in this embodiment, the migrating node which the UE served by may establish an F1-C connection with the target donor node, and the source donor node may perform the step 601 of FIG. 6 before or after the F1-C is established. Exemplarily, the migrating node which the UE served by may establish an F1-C connection with the target donor node, and the migrating node which the UE served by, the source donor node, and the target donor node may interact with each other through the steps 401 to 404 as shown in FIG. 4. After the step 404, i.e., after the source donor node receives the UE context handover request ACK message of the target donor node, step 203 is performed; and the present disclosure does not limit when the source donor node transmits the first information to the UE. That is, the source donor node may perform the above implementation before or after any of the steps 401 to 404 as shown in FIG. 4; the present disclosure does not limit the execution order of the above implementation and the steps 401 to 404.

In yet another embodiment, the present disclosure also proposes an implementable way for transmitting a handover command by group. Exemplarily, the source donor node may group individual UEs and transmit the handover command to the corresponding group requiring context handover. The first information includes the first inquiry message or first indication information; then the following steps S2 and S3 are included before the step 602 of FIG. 6, and accordingly, the step 602 may be implemented by the following steps S4 and S5. In a possible implementation, the method for transmitting a handover command may include the following steps S1 to S5:
Step S1: transmitting first information to the user equipment (UE).
Step S2: receiving the first assistance information transmitted by the UE based on the first information.
Step S3: transmitting grouping information to the UE based on the first assistance information, the grouping information being configured to indicate a group which the UE belongs to.
wherein, based on the first assistance information, the UEs are divided into at least one group.
Step S4: transmitting second indication information to the corresponding group for which the context handover is to be performed.
Step S5: transmitting a handover command to the corresponding group for which the context handover is to be performed.

Accordingly, the UE may perform the following step after the step S1: transmitting first assistance information to the source donor node based on the first information; receiving the grouping information transmitted by the source donor node. And, the UE may perform the following after the step S4; receiving the second indication information transmitted by the source donor node. Then the step of the UE receiving the handover commands transmitted by the source donor node may include: the UE receiving the handover command transmitted by the source donor node, based on the second indication information.

Wherein, the second indication information is configured to indicate that each UE included in the corresponding group receives the handover command.

Exemplarily, the first information may be a first inquiry message or first indication information. Exemplarily, the UE may add a reply to the first information in the UAI, generate the first assistance information, and report the first assistance information to the source donor node.

The grouping information may include the identifier of the group which the UE belongs to, for example, a group ID of the group which the UE belongs to. In one example, the source donor node may broadcast to the UE second system information carrying grouping information that may include an association between each UE and the group which it belongs to. For example, the grouping information may include the ID of each UE and the group ID of each group which the UE belongs to. For example, the grouping information is added to an information block to generate a group decision IE (group decision information element), which is added to the SIB to generate the second system information; wherein the group decision IE is added to the SIB in the SIB to generate the second system information; wherein the group decision IE carries a correspondence among the UE ID and the group ID corresponding to each UE. In another example, the source donor node may return the group to which each UE belongs separately to each UE, and the grouping information includes the group which the UE belongs to. The source donor node adds the grouping information to the information block, generates a first downlink message, and transmits the first downlink message to the UE. For example, for each UE, the source donor node transmits a first downlink message to the UE, which may include the group ID of the group which that UE belongs to, e.g., the grouping information is added to the dedicated signal of the downlink RRC message to generate the first downlink message to inform each UE of the corresponding group ID of the UE.

In one possible implementation, the first assistance information includes at least one of the following items:
a traffic period of the UE;
a time at which the UE expects context handover;
a time period during which the UE expects context handover.

For example, the source donor node may divide the UEs with the same or similar first assistance information into a group based on the first assistance information. For example, the UEs whose context handover time vary within a first threshold are divided into a group.

In one alternative embodiment, the second indication information includes at least one of the following items:
a notification message which is configured to notify each UE included in the corresponding group for which context handover is to be performed of the context handover;
a time-frequency resource used by each UE included in the corresponding group to receive the handover command;
a group identifier of the corresponding group.

For example, if the current group to be performed of the context handover is group2, second indication information is transmitted to each UE in group2, and each UE may determine whether it is its own group based on the group ID (group2) carried in the second indication information. If they are in their own group, i.e., the resources such as the time slot and frequency used by each UE belongs to group2 when the context handover is required or by each UE when the context handover is performed.

In one possible implementation, the source donor node may also transmit a handover request to the target donor node by group to obtain the context configuration information of the corresponding group. Exemplarily, the step S4 may include the following steps: the source donor node transmits a handover request to the target donor node to request context handover for the corresponding group to be performed of the context handover; the target donor node transmits a handover request acknowledgement message for the corresponding group to the source donor node, the handover request acknowledgement message carrying the context configuration information for each UE in the corresponding group to be performed of the context handover; the source donor node transmits second indication information to the corresponding group to be performed of the context handover according to the handover request acknowledgement message.

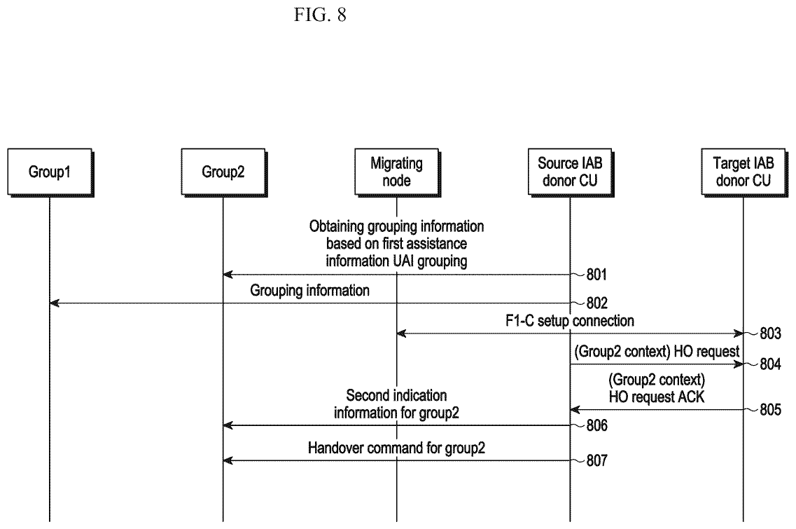

FIG. 8 is a schematic diagram of a process for a method of transmitting a handover command by group provided in an embodiment of the present disclosure. Taking the process shown in FIG. 8 as an example, the process may include the steps of interaction between the source IAB donor CU, the migrating node, the UE, and the target IAB donor CU. The process of transmitting a handover command for context handover by group may include the following steps 801 to 807;
Step 801: the source IAB donor CU transmits first information to the UE, the first information may include a second inquiry message, the second inquiry message is configured to ask the UE about the time (time point or time period) at which the UE expects to perform the context handover. The UE may add reply information to the second inquiry message to the UAI, generate first assistance information, and report the first assistance information. The UE reporting the first assistance information may include at least one of the following ways:
Way 1: reporting the traffic period of the UE via UAI;
Way 2: reporting the time when the UE expects context handover (preferred migrating time) via UAI;
Way 3: reporting the UE preferred migrating time interval for the context handover via UAL
Step 802: the source IAB donor CU groups the UEs according to the first assistance information reported by the UE and transmits grouping information to the UE; for example, the grouping information may be added in the information block IE (e.g., grouping decision IE), and the grouping information may carry the group ID of the group which the UE belongs to; wherein, the grouping information may be transmitted to the UE by the following two ways:
Way 1: adding the IE including the grouping information to the SIB message, generating the second system information, and broadcasting the second system information to each UE; wherein the grouping information includes the correspondence among each UE ID and the group ID.
Way 2: adding the dedicated signal including the grouping information in the downlink RRC message, generating the first downlink message, and transmitting the first downlink message to the UE; wherein the grouping information includes the group ID of the group which the UE belongs to.
Step 803: After the source IAB donor CU determines to perform the migration of the F1 termination, the migrating node initiates the F1-C setup process.

Wherein, the steps 801 and 802 may be executed before or after the step 803, and the present disclosure does not limit the execution order of the steps 801, 802 and the step 803.
Step 804: After the F1-C is established, the source IAB donor CU may determine the context handover order of each group according to the grouping information, for example the source IAB donor CU determines that group2 is the first to perform the context handover; the source IAB donor CU transmits a handover request (HO request) for the context handover of each UE in group2 to the target IAB donor CU.

For example, the source IAB donor CU may transmit the context HO requests of all UEs in group 2 to the target IAB donor CU at one time via Xn interface.
Step 805: the target IAB donor CU transmits a handover request acknowledgement message HO request ACK to the source IAB donor CU.
Step 806: the source IAB donor CU transmits second indication information (migration indication for group 2) for the current group to be performed context handover; wherein the second indication includes the following three functions:
Point 1: indicating that each UE in group 2 is to perform context handover,
Point 2: indicating the respective time-frequency resources corresponding to each UE in the group2;
Point 3: the second indication information carries the group ID (e.g., group2) so that each UE determines whether to notify itself based on the group ID; if each UE belonging to group 2 determines to notify itself, it starts preparing to receive the handover command based on point 1 and point 2.
Step 807: the UEs in the group 2 receive the handover command (UE context modification) transmitted by the source IAB donor CU on the corresponding time-frequency resource according to the second indication information.

The method for transmitting handover command provided by the present disclosure achieves UE context handover from the source donor node to the target donor node by transmitting first information to a user equipment (UE), the first information being configured to assist the source donor node in UE context handover; and transmitting a handover command to the UE. This enables the source donor node to perform the UE context handover with the assistance of the first information, which helps to avoid a sudden increase in signaling overhead via UU interface due to a large number of UE context handovers in a short period of time, helps to avoid problems such as interruption and retransmission of uplink data transmission caused by conflicts between uplink data transmission and UE context handover, improves UE communication service quality and enhances the user experience.

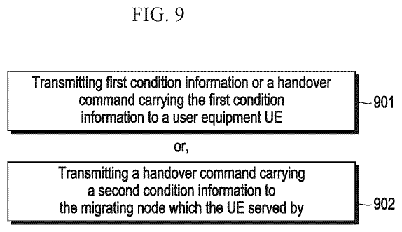

When the source IAB donor CU transmits a handover command to the UE, the UE may execute the handover command immediately. However, in some cases, if the connection quality between the migrating node which the UE served by and the source link is not good, the source link may suddenly break; at this time, the UE that has not completed the context transfer cannot receive the handover command transmitted by the source IAB donor CU, and cannot obtain the handover command from the source IAB donor CU, so the UE cannot be migrated from the source IAB donor CU to the target IAB donor CU, and the UE cannot receive the message from the target IAB donor CU for data interaction. Moreover, the source IAB donor CU is unable to transmit the handover command to the UE, and it will choose other ways, such as trying to transmit the handover command to the UE via the target IAB donor CU, which will lead to a corresponding delay problem when the UE performs the context handover. Based on this, the present disclosure designs a method for transmitting a handover command to solve the above problems; the method is described below with reference to the flow shown in FIG. 9.

FIG. 9 is a schematic flow diagram of a method for transmitting a handover command provided in an embodiment of the present disclosure. The method is performed by a source donor node, which may, for example, be performed by a source IAB donor CU. As shown in FIG. 9, the method includes the following step 901 or step 902.
step 901: transmitting first condition information or a handover command carrying the first condition information to the user equipment (UE).
or,
step 902: transmitting a handover command carrying the second condition information to the migrating node which the UE served by;

Wherein, the first condition information is configured to indicate the condition to be satisfied for the UE to perform the context handover, the second condition information is configured to indicate the condition to be satisfied for the migrating node to transmit a handover command to the UE, and the handover command is configured to perform UE context handover from the source donor node to the target donor node.

Corresponding to step 901 above, the UE may perform the following steps: the UE receives the first conditional information or the handover command carrying the first conditional information transmitted by the source donor node. Moreover, the UE performs the UE context handover from the source donor node to the target donor node if the first conditional information is satisfied.

Corresponding to step 902 above, the UE may perform the following steps: the UE receives a handover command carrying the second condition information transmitted by the migrating node. Further, the UE performs the UE context handover from the source donor node to the target donor node based on the handover command transmitted by the migrating node. Corresponding to step 902 above, the migrating node may perform the following steps:
the migrating node receives a handover command carrying the second condition information transmitted by the source donor node;
if the migrating node satisfies the second condition information, the migrating node transmits a handover command to the UE. Wherein, the second condition information is configured to indicate the condition to be satisfied for the migrating node to transmit the handover command to the UE.

Exemplarily, the UE or migrating node may also provide feedback to the source donor node, and the method for transmitting a handover command may further include at least one of the following items:
receiving the third indication information transmitted by the UE;
receiving the fourth indication information transmitted by the migrating node which the UE served by;
wherein the third indication information is configured to indicate at least one of the following items: that the UE satisfies the first condition information, that the UE performs context handover, and an identifier of the UE performing the context handover in case the first condition information is satisfied.
the fourth indication information is configured to indicate at least one of the following items: the migration node satisfies the second condition information, the migration node transmits a handover command to the UE, an identifier of the UE performing the context handover in case the migration node satisfies the second condition information.

For example, the identifier of the UE may be the UE ID.

In a first alternative embodiment, the source donor node performs transmitting a handover command carrying the first condition information to the UE.

The first condition information includes at least one of the following items:
a deadline threshold for the UE to perform context handover;
a time point or time interval at which the UE performs context handover;
receipt of a handover indication from a migration node which the UE served by;
a change in a cell global identifier (NRCGI) of the migration node which the UE served by;
a UE has no uplink or downlink traffic;
a UE is required to perform context handover;
completion of the last uplink or downlink traffic by a UE;
a UE has no uplink or downlink traffic in a first predefined time period.

Exemplarily, the first condition information is not limited to at least one of the above, for example, the first condition information may also include: the conditions given by the source donor node or the migrating node UE served by through the implementation.

Wherein, the deadline threshold of the context handover, the first predetermined time period may be configured based on demand, and the present disclosure does not limit this. For example, the first predetermined time period may be: 3 seconds, 0.5 seconds, 5 milliseconds, etc. after the UE receives the first condition information or the handover command carrying the first condition information.

The UE may, based on the first condition information carried by the handover command, perform context handover based on the handover command when it determines that the first condition information is satisfied. The UE may also transmit third indication information to the source donor node, and the source donor node receives the third indication information transmitted by the UE.

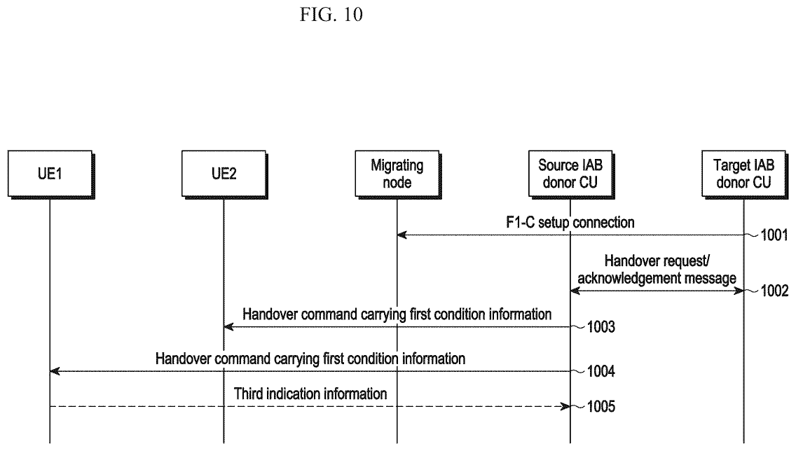

FIG. 10 is a schematic diagram of a process for transmitting a handover command carrying first condition information provided in the present disclosure, and the process of transmitting a handover command carrying first condition information is described in FIG. 10 below as an example. The process may include the steps of interaction between the source IAB donor CU, the migrating node, the UE, and the target IAB donor CU. As shown in FIG. 10, the process includes the following steps 1001 to 1004:
Step 1001: the migrating node triggers the F1-C connection setup process, and the F1-C connection is established between the migrating node and the target IAB donor CU.
Step 1002: a (UE context) HO request/response interaction process is performed between the source IAB donor CU and the target IAB donor CU, the process may include:

the source IAB donor CU transmits a handover request (UE context) HO request (HO request for the UE context) to the target IAB donor CU;
the target IAB donor CU agrees and replies to the source IAB donor CU with a handover request response message (UE context) HO response, which may carry the handover command.
Step 1003: the source IAB donor CU transmits a UE context modification (HO command, HO CMD) with condition carrying the first condition information to the UE; the UE does not immediately execute the HO CMD, but executes the HO CMD after determining that the first condition information is satisfied; wherein the first condition information may include at least one of the following (a)-(i):
(a) a time threshold: condition indicating the deadline for the UE to execute the HO CMD;
(b) a time interval/point: the time interval/point at which the UE is required to perform the HO CMD, indicating the condition under which the UE is to perform the HO CMD at the time point or time interval during which context handover is allowed;
(c) a condition indicating to execute by the UE upon receipt of an indication from the migrating node;
(d) a condition indicating to staring executing when the NRCGI broadcast by the migrating node changes;
(e) a condition to be executed when a UE has no uplink or downlink traffic;
(f) a condition indicating that the UE executes at the context handover time expected by the UE, the context handover time expected by the UE may be implemented by the UE;
(g) executing when the UE has completed its last uplink and downlink traffic;
(h) executing when there are no uplink and downlink traffic in the first predetermined period of the UE;
executing when the condition given by the source donor node or the migrating node is satisfied by the implementation,
Step 1004: the UE1 receives the UE context modification (HO command) carrying the first condition information and executes the UE context handover after the first condition information is satisfied.
Step 1005: the UEl may transmit third indication information to the source IAB donor CU.
In a possible example, the above conditions (a)-(i) may also be used in the following scenario: a scenario where the PCI (Physical Cell Identifier) of a neighbor cell is in conflict when the migrating node moves and needs to be modified. A method for modifying the PCI is provided below, which includes the following steps A1 and A2:
Step A1: the source IAB donor CU transmits first condition information to the migrating node, the first condition information may be configured to indicate the condition to be satisfied to modify the PCI.

For example, the first condition information may also include at least one of conditions (a)-(i) as described above.

Step A2: When the PCI of the migrating node conflicts with the neighbor cell, the migrating node modifies its own PCI according to the instructions of the source IAB donor CU if the first condition information is satisfied.

In a possible example, after the step 901 of the FIG. 9, the UE may also transmit third indication information to the source donor node, the source donor node receives the third indication information transmitted by the UE.

For example, the UE may transmit the third indication information to the source IAB donor CU after the condition has been satisfied, in order for the source IAB donor CU to be informed which UEs have performed the context handover and which UEs have not yet performed it.

In a second alternative embodiment, the source donor node performs step 902, and after the step 902 of the FIG. 9, the following step 903 (not depicted) is also performed by the migrating node, exemplarily, the method for transmitting a handover command may include the following steps 902-903:
Step 902: the source donor node transmits a handover command carrying the second condition information to the migrating node which the UE served by.
Step 903: if the migrating node determines that the second condition information is satisfied, the migrating node transmits a handover command to the UE.

For example, the source IAB donor CU transmits a handover command (UE context) HO CMD carrying the condition to the migrating node, and if certain conditions are satisfied, the migrating node transmits a handover command to the UE.

Wherein, the second condition information includes at least one of the following items:
a deadline threshold for the UE to perform context handover;
a time point or time interval at which the UE performs context handover,
the migration node which the UE served by has a time-frequency resource;
a reference signal received power RSRP value of the migrating node which the UE served by is not higher than a first threshold;
a change in a cell global identifier (NRCGI) of the migration node which the UE served by;
the UE has no uplink or downlink traffic;
completion of the last uplink or downlink traffic by the UE;
the UE has no uplink or downlink traffic in a first predefined time period.

Exemplarily, the second condition information is not limited to at least one of the above, for example, the second condition information may also include: the conditions given by the source donor node or the migrating node UE served by through the implementation.

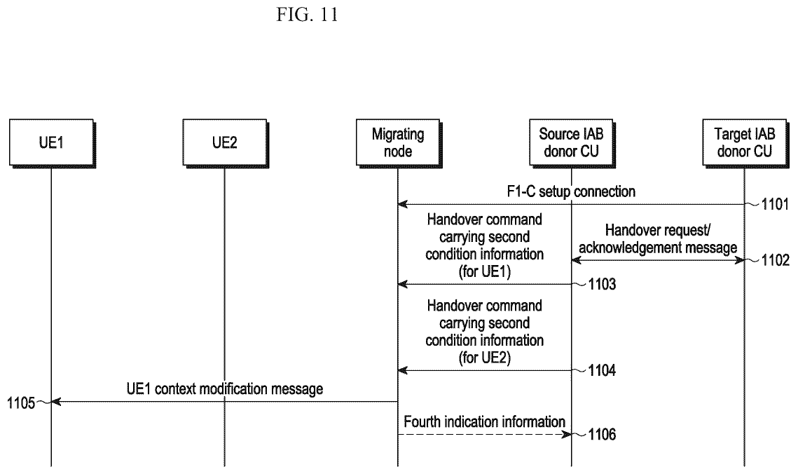

FIG. 11 is a schematic diagram of a process method for transmitting a handover command carrying second condition information provided in the present disclosure, the process may include the steps of interaction between the source IAB donor CU, the migrating node, the UE, and the target IAB donor CU. Hereinafter, using FIG. 11 as an example, if the source donor node transmits a handover command carrying the second conditional information to the migrating node, the process for transmitting the handover command includes the following steps 1101 to 1106;
Step 1101: the migrating node triggers the F1-C setup process, and the F1-Cl connection is established between the migrating node and the target IAB donor CU.
Step 1102: the process of (UE context) HO request/response interaction between the source IAB donor CU and the target IAB donor CU, is the same process as the step S2 corresponding to FIG. 10 in the first embodiment and will not be repeated here.
Steps 1103, 1104: the source IAB donor CU transmits a handover command HO CMD with condition carrying the second condition information to the migrating node, and after the migrating node receives the handover command, it does not transmit the handover command to the UE immediately, but after the second condition information is satisfied, the migrating node then transmits the handover command to the UE.

Wherein the second condition information may include at least one of (a)-(i) of the following:
(a) a time threshold: indicating to execute before the deadline when the UE executes the HO CMD.
(b) a time interval/point: the time interval/point at which the UE is to perform HO CMD, indicating that it is to be performed at the point or time interval during which context handover is allowed;
(c) indicating the migrating node to execute when the time infrequent resources are available;
(d) indicating to execute when the RSRP value of the migrating node is lower than a certain threshold;
(e) indicating to execute when the migrating node is about to change the NRCGI;
(f) indicating to execute when the UE has no uplink and downlink traffic;
(g) executing when the UE has completed the last uplink and downlink traffic;
(h) executing when there are no uplink and downlink traffic in the first predetermined period of the UE;
(i) indicating to execute under conditions that satisfy the condition given by the implementation of the source donor node or migrating node.
Step 1105: after the second condition information is satisfied, the migrating node transmits the handover command HO CMD (included in the UE context modification) to the UE;
exemplarily, after the step 902 of the FIG. 9, Step 1105: the migrating node transmits fourth indication information to the source donor node, and the source donor node receives the fourth indication information transmitted by the migrating node. For example, the migrating node may transmit the fourth indication information to the source IAB donor CU after the condition is satisfied; such that the source IAB donor CU is informed which UEs have performed the context handover and which UEs have not yet performed.

In a third alternative embodiment, the source donor node performs the step 901: the source donor node transmits first condition information or a handover command carrying the first condition information to the UE. The UE may also transmit a handover request to the migrating node or the source donor node which the UE served by, if it determines that the first condition information is satisfied, the handover request is configured to request the execution of context handover. The migrating node or source donor node which the UE served by triggers the UE to perform or not perform the context handover.

In one possible implementation, the UE may transmit a handover request to the source donor node, and the method for transmitting a handover command may include the following steps B1 to B6:
Step B1: the source donor node transmits first condition information or a handover command carrying the first condition information to the UE.
Step B2: the UE receives the first condition information or a handover command carrying the first condition information.
Step B3: the UE transmits a first request to the source donor node if the first condition information is satisfied. Wherein, the first request is configured to request the execution of context handover. For example, the first condition information may be configured to indicate the condition information to be satisfied by the UE when requesting context handover from the source donor node.
Step B4: the source donor node receives the first request transmitted by the UE in case the first condition information is satisfied.
step B5: the source donor node transmits a handover command or a rejection of handover command to the UE based on the first request in case the source donor node transmits the first condition information to the UE;
the source donor node transmits fifth indication information to the UE based on the first request in case the source donor node transmits a handover command carrying the first condition information to the UE.
Step B6: if the first condition information transmitted by the source donor node is received, the UE receives the handover command or the rejection of handover command transmitted by the source donor node; if the handover command carrying the first condition information transmitted by the source donor node is received, the UE receives the fifth indication information transmitted by the source donor node.

Wherein, the fifth indication information is configured to indicate whether the handover command is activated or not. If the fifth indication indicates activation of the handover command, the UE executes the handover command, i.e., the UE performs the context handover. If the fifth indication information indicates not to activate the handover command, or the source donor node transmits the rejection of handover command to the UE; the UE does not perform the handover command, i.e., the UE does not perform the context handover.

In another possible implementation, the UE may transmit a handover request to the migrating node which the UE served by, and the method for transmitting the handover command may include the following steps C1 to C6:
Step C1: the source donor node transmits first condition information or a handover command carrying the first condition information to the UE.
Step C2: the UE receives the first condition information or a handover command carrying the first condition information.
Step C3: the UE transmits a first request to the migrating node which the UE served by if the first condition information is satisfied. For example, the first condition information may be configured to indicate the condition information to be satisfied by the UE when requesting context handover from the source donor node.
wherein the first request is configured to request the execution of context handover.
Step C4: the migrating node receives the first request transmitted by the UE in case the first condition information is satisfied.
Step C5: the migrating node transmits a handover command or the rejection of handover command to the UE based on the first request if the source donor node transmits the first condition information to the UE; the migrating node which the UE served by transmits fifth indication information to the UE based on the first request if the source donor node transmits a handover command carrying the first condition information to the UE.
Step C6: the UE receives the handover command or the rejection of handover command transmitted by the migrating node if the first condition information transmitted by the source donor node is received; the UE receives the fifth indication information transmitted by the migrating node if the handover command carrying the first condition information transmitted by the source donor node is received.

Wherein the fifth indication information is configured to indicate whether to activate the handover command.

In an example, in the step B6 or step C6, if the UE performs the handover command, the UE may transmit third indication information to the source donor node; the source donor node receives the third indication information transmitted by the UE.

In another example, in step 706, if the migrating node transmits a handover command to the UE, or if the migrating node transmits fifth indication information to the UE for indicating the activation of the handover command, the migrating node transmits fourth indication information to the source donor node, and the source donor node receives the fourth indication information transmitted by the migrating node which the UE served by; such that the source donor node is informed which UEs have performed the context handover and which UEs have not yet performed the context handover.

In another possible implementation, the migrating node may also transmit a request to the source donor node, the source donor node decides whether the migrating node triggers the UE to perform context handover, exemplarily, the handover execution transmitting process may include the following steps D1 to D6:
Step D1: the source donor node transmits second condition information or a handover command carrying the second condition information to the migrating node. For example, the second condition information may be configured to indicate the condition information to be satisfied when the migrating node requests the source donor node to trigger UE context handover.
Step D2: the migrating node receives the second condition information or the handover command carrying the second condition information transmitted by the source donor node.
Step D3: the migrating node transmits a second request to the source donor node in case the second condition information is satisfied. The second request is used, for example, to trigger the UE to perform context handover
Step D4: the source donor node receives the second request transmitted by the migrating node.
step D5: if the source donor node transmits second condition information to the migrating node in the step D1, the source donor node transmits a handover command or a rejection of handover command to the migrating node in the step D5.

If in the step DI the source donor node transmits a handover carrying the second condition information to the migrating node, then in the step D5 the source donor node transmits ninth indication information to the migrating node.

Wherein, the ninth indication information is configured to indicate whether to transmit the handover command to the UE. If the ninth indication information indicates that the handover command is transmitted to the UE, or the source donor node transmits the handover command to the migrating node, the migrating node transmits the handover command to the UE, the UE receives and executes the handover command, and performs the context handover according to the handover command. If the ninth indication information indicates not to transmit the handover command to the UE, or the source donor node transmits the rejection of handover command to the migrating node; then the migrating node does not transmit the handover command to the UE, and the UE does not perform the context handover.

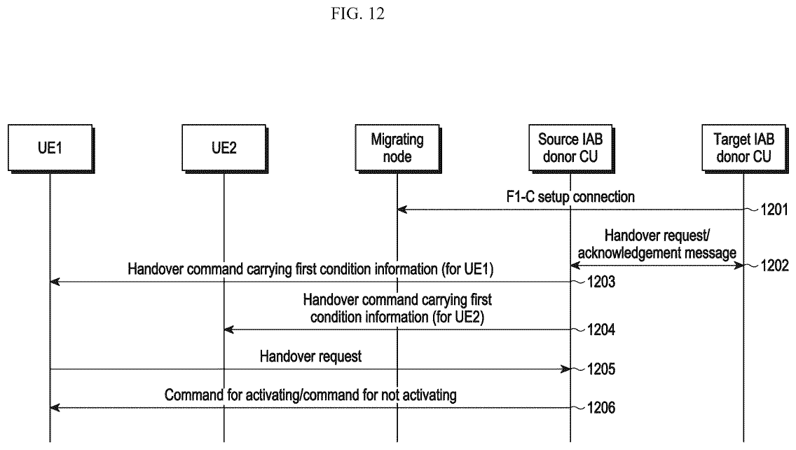

FIG. 12 is a schematic diagram of context handover process which including transmitting a handover request process by a UE provided by the present disclosure, the process may include steps of interaction between a source IAB donor CU, a migrating node, a UE, and a target IAB donor CU. As an example, in FIG. 12 below, if the UE transmits a handover request to the source IAB donor CU or the migrating node which the UE served by, the handover command transmitting process includes the following steps 1201 to 1206:
Step 1201: the migrating node triggers the F1-C setup process and an F1-C connection is established between the migrating node and the target IAB donor CU.
Step 1202: the process of (UE context) HO request/response interaction between the source IAB donor CU and the target IAB donor CU, is the same process as the step 1202 corresponding to FIG. 10 in the first embodiment and will not be repeated here.
Steps 1203, 1204: the source IAB donor CU transmits first condition information or a handover command carrying the first condition information (HO command with condition) to the UE, wherein the first condition information may include, but is not limited to, the conditions (a)-(i) in FIG. 10 corresponding to the step 1203, 1204, which are not repeated here.
Step 1205: when the UE satisfies the first condition information, the UE may transmit a handover request (HO request) to the source IAB donor CU or the migrating node which the UE served by, for example, the UE may add the handover request to the uplink RRC signaling, and the UE transmits an uplink RRC signaling carrying the handover request to the migrating node which the UE served by or the source IAB donor CU; for example, the UE transmits the handover request by at least one of the following two ways:
way 1: the UE transmits uplink RRC signaling carrying the handover request to the migrating node, and the migrating node decides whether the UE will perform the context handover.
way 2: the UE transmits uplink RRC signaling carrying the handover request to the source IAB donor CU, and the source IAB donor CU decides whether the UE performs the context handover.
Step 1206: the migrating node or source IAB donor CU, agrees with the UE to perform the context handover or to reject the UE to perform the context handover, including the following four cases;
If way 1 in the step 1205 is used, i.e., the migrating node decides whether the UE performs context handover, the step 1206 includes the following cases 1 and 2:
Case 1: if the source IAB donor CU transmits first condition information to the UE the migrating node receives a handover request of the UE; for the step 1206, the migrating node transmits a handover command or the rejection of handover command to the UE;
Case 2: if the source IAB donor CU transmits a handover command carrying first condition information (HO CMD with condition) to the UE, the migrating node receives the handover request of the UE; for the step 1206, the migrating node transmits fifth indication information to the UE indicating the activation or inactivation of the handover command of the UE.

If way 2 in the step 1205 is used, i.e., the source IAB donor CU decides whether the UE performs context handover, including the following cases 3 and 4:
Case 3: if the source IAB donor CU transmits first condition information to the UE, the source IAB donor CU receives a handover request of the UE; for the step 1206, the source IAB donor CU transmits the handover command or the rejection of handover command to the UE,
Case 4: if the source IAB donor CU transmits to the UE a handover command carrying the first condition information (HO CMD with condition), the source IAB donor CU receives the handover request of the UE; for the step 1206, the source IAB donor CU transmits to the UE fifth indication information indicating the activation or inactivation of the UE of the handover command.

It should be noted that when the source IAB donor CU originally determines that the migrating node moves to the target IAB donor CUI, but the migrating node subsequently moves to the target IAB donor CU2, accordingly, the source IAB donor CU or the migrating node may reject the handover request (HO request) of the UE to move the context to the target IAB donor CU1 to avoid the UE context handover to an inappropriate donor node and to ensure that the UE context handover is performed to a valid target donor node, thus ensuring the reliability and accuracy of the context handover.

The present disclosure provides a method for transmitting a handover command, includes: transmitting first condition information or a handover command carrying the first condition information to a user equipment (UE); or, by transmitting a handover command carrying second condition information to a migrating node which the UE served by; wherein the first condition information is configured to indicate a condition to be satisfied for the UE to perform context handover, and the second condition information is configured to indicate a condition to be satisfied for the migrating node to transmit a handover command to the UE. Based on the conditions, the UE is allowed to perform context handover, thus combining the conditions to control when or how the UE performs context handover, which enables effective control of context handover by the UE, avoiding problems such as inability to perform context handover or delays due to sudden disconnection, and ensuring the reliability of UE context handover.

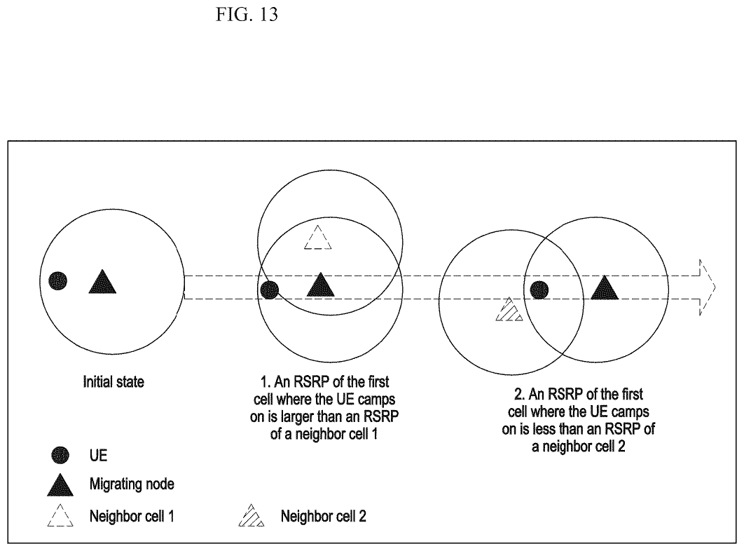

When the UE is in idle state, the UE served by the migrating node has a higher probability of reselection to wrong cell. For example, when the mobile IAB node is supported in the future, for example, the application scenario of the migrating node includes vehicle mounted relay (VMR), for the UE in idle state that moves as the migrating node moves, there may be cases where higher RSRP values are temporarily measured in a neighbor cell during the cell measurement, the corresponding diagram is shown in FIG. 13, if the cell on which the UE in the idle state camps on is re-selected to the neighbor cell, the measurement is performed according to the frequency (frequency list) and priority in the system information SIB broadcasted by the neighbor cell. However, this is inappropriate for UEs that have been moving with the migrating node and may, for example, lead to UEs not being able to reselect to a suitable cell or to camp on the migrating node, thus leading to frequent cell reselection by the UE and increasing power consumption.

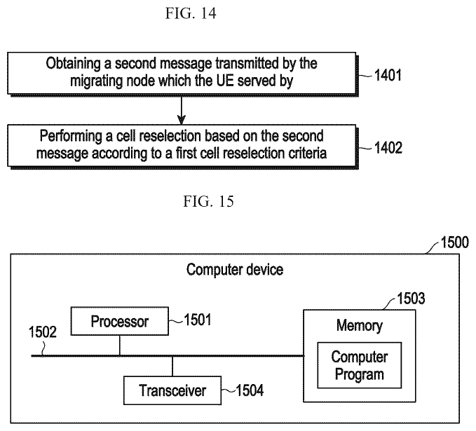

Based on this, the present disclosure designs a cell reselection method to solve the above problems; the method is described below with reference to the process shown in FIG. 14.

FIG. 14 is a schematic flow diagram of a cell reselection method provided by an embodiment of the present disclosure; the method is performed by a UE, as shown in FIG. 14, and the method includes the following steps 1401 and 1402:
step 1401: receiving a second message transmitted by the migrating node which the UE served by.
Step 1402: performing a cell reselection according to the first cell reselection criteria based on the second message.

Wherein the UE camps on the first cell and the cells included in the migrating node include that first cell.

Exemplarily, the first cell reselection criteria may include a new cell reselection criteria. The existing cell reselection criteria may be referred to as a second cell reselection criteria. The second message may be an RRC message, for example, the second message is a second downlink message.

It should be noted that the cell reselection criteria may include the following three cases:
Case 1: when the current serving cell is with an equal priority (with same frequency) to the neighbor cell, i.e., when reselecting among cells with an equal priority/same frequency: the cell with the largest RSRP value is selected to camp on.
Case 2: when the frequency used by the current serving cell is with a higher priority than the priority of the frequency used by the neighbor cell, i.e., when reselecting from the currently serving cell using a frequency with a higher priority to the neighbor cell using a frequency with a lower priority, if the RSRP value of the cell using the frequency with the higher priority is less than a certain threshold and the RSRP value of the neighbor cell using the frequency with the lower priority is greater than a certain threshold, the neighbor cell using the frequency with the lower priority is reselected to camp on.
Case 3: when the frequency used by the current serving cell is with a lower priority than the priority of the frequency used by the neighbor cell, i.e., when reselecting from the cell using a frequency with a lower priority to the cell using a frequency with a higher priority: if the RSRP value of neighbor cell using the frequency with a higher priority is greater than a certain threshold, then the neighbor cell may be re-selected to camp on.

In case of reselection among cells with an equal priority/same frequency, if the UE reselects from the first cell where the UE currently camps on to the neighbor cell 1, as shown in FIG. 13, then the UE reselects to a neighbor cell 2 with a higher priority based on the SIB message of the neighbor cell 1, but the SIB message of the neighbor cell 2 does not contain the frequency used by the first cell, the UE cannot reselect from the neighbor cell 2 to the first cell; when the list of frequencies in the SIB of an intra-frequency neighbor cell does not contain the first cell, the UE cannot re-Substitute camp on the first cell either. Therefore, if the UE cannot find a suitable cell, it will perform the cell reselection, which increases the delay and power consumption.

The cell reselection method of the present disclosure may avoid the problems of time delay and power consumption caused by cell reselection via making such UEs camp on the first cell as much as possible during the cell reselection process.

In a possible implementation, if the frequency used by the first cell is with an equal priority to the priority of the frequency used by the neighbor cell; whether to perform a cell reselection may be determined based on the reference signal received power RSRP value of the first cell and the RSRP value of the measured cells. Exemplarily, the first cell reselection criteria may include at least one of the following items:
if the difference between the reference signal received power RSRP value in the first cell, and the highest RSRP value of the measured cells is higher than the second threshold, the UE performs a cell reselection;
if the RSRP value of the first cell in the first predetermined time measurement is lower than the highest RSRP value in the cell measurement, the UE performs a cell reselection;
if the RSRP value of the first cell is lower than the third threshold, the UE performs a cell reselection.

Wherein the measured cells include the first cell where the UE camps on and the neighbor cell.

Exemplarily, if the difference between the reference signal received power RSRP value of the first cell, and the highest RSRP value of the measured cells is not higher than the second threshold, the UE does not perform a cell reselection. If the RSRP value of the first cell is not lower than the third threshold, the UE does not perform cell reselection.

Exemplarily, the RSRP value of the first cell is not the highest among the measured cells, but the difference between the RSRP value of the first cell and the highest RSRP value among the cells in the measured cells is less than a certain threshold, such as the second threshold, then cell reselection is not performed. Therefore, even if the first cell is not the best, the UE continues camping on the first cell without significant impact on the communication service, effectively avoiding problems such as delay and power consumption caused by the UE's inability to find a suitable cell.

Exemplary, the first predetermined time measurement may be configured based on demand, for example, the first predetermined time measurement may be consecutive multiple time measurements, such as consecutive 5 measurements, 20 measurements, etc., which is not specifically limited in the present disclosure. For example, if the RSRP value of the first cell is not the highest value among the measured cells during n consecutive measurements, the UE is considered for cell reselection to avoid the error of a single measurement, which improve the robustness of the cell reselection, and let the UE continue to camp on the first cell as much as possible to effectively avoid the problems of delay and power consumption.

Exemplarily, the cell reselection is not performed when the RSRP value of the first cell is not lower than a certain threshold, such as not lower than the third threshold; the UE may be allowed to perform the cell reselection when the RSRP value of the first cell is lower, which may effectively ensure the quality of service of the UE.

In another possible implementation, if the frequency used by the first cell is with a priority higher than the priority of the frequency used by the neighbor cell, whether to perform a cell reselection may be determined based on the RSRP value of the first cell and the RSRP value of the measured cells. Exemplarily, the first cell reselection criteria may include at least one of the following items:
if the RSRP value of the first cell at the second predetermined time measurement is less than a fourth threshold and the RSRP value of the neighbor cell at the second predetermined time measurement is greater than a fifth threshold, the UE performs a cell reselection.

If the RSRP value of the first cell is not less than a sixth threshold, or the RSRP value of the neighbor cell is not greater than a seventh threshold, the UE performs a cell reselection.

Exemplarily, if the RSRP value of the first cell is less than a sixth threshold and the RSRP value of the neighbor cell is greater than a seventh threshold, the UE does not perform the cell reselection.

Exemplarily, the second predetermined time measurement may be set based on demand, for example, the second predetermined time measurement may be multiple consecutive measurements, without any specific limitation in the present disclosure. For example, during n consecutive measurements: the RSRP of the first cell is less than a certain threshold (e.g., the fourth threshold) and the RSRP of the neighbor cell is greater than a certain threshold (e.g., the fifth threshold), then cell reselection is performed. By considering the results of multiple measurements to determine whether to reselect, only a single measurement will not trigger the cell reselection, allowing the UE to camp on the first cell as much as possible to avoid delay and power consumption problems and improve the robustness of cell re-selection.

Exemplarily, the RSRP value of the first cell is less than a new threshold, such as the sixth threshold, and the RSRP value of the neighbor cell is greater than a legacy threshold, such as the seventh threshold, then no cell reselection is performed.

In another possible implementation, if frequency used by the first cell is with a priority lower than the priority of the frequency used by the neighbor cell; whether to perform a cell reselection may be determined based on the RSRP value of the first cell and the RSRP in the measured cells. Exemplarily, the first cell reselection criteria may include:
if the RSRP value of the neighbor cell in the third predetermined time measurement is greater than the eighth threshold, the UE performs the cell reselection.

For example, the third predetermined time measurement may be set based on demand, for example, the third predetermined time measurement may be consecutive multiple measurements, which is not specifically limited in the present disclosure. For example, in the process of n consecutive measurements: the RSRP value of the neighbor cell is greater than a certain threshold, such as the eighth threshold, the cell reselection is performed. By considering the results of multiple measurements to determine whether to reselect, only a single measurement will not trigger the cell reselection, allowing the UE to camp on the first cell as much as possible, avoiding delay and power consumption problems, and improving the robustness of cell reselection.

It should be noted that each threshold involved in the present disclosure, such as the first threshold, the second threshold, . . . , the eighth threshold, etc., may be set based on demand, and the present disclosure does not limit the specific value size of each threshold.

In a further possible implementation, the second message includes at least one of the following items:
sixth indication information, the sixth indication information being configured to indicate that the cell reselection is to be performed according to the first cell reselection criteria;
seventh indication information, the seventh indication information being configured to indicate to not according to the first cell reselection criteria;
eighth indication information, the eighth indication information being configured to indicate that the cell reselection is to be performed according to the criteria specified in the first cell reselection criteria;
the first cell reselection criteria;
a first offset value;
a first priority.

Exemplarily, the migrating node may generate a second message based on at least one of the above items and transmit the second message to the UE, the UE receives the second message. The UE is enabled to perform the cell reselection based on the indication of at least one items in the second messages.

In another possible implementation, the priority of the frequency used by the cell may be dynamically adjusted, and the cell reselection may be performed in conjunction with the second cell reselection criteria. Exemplarily, if based on the indication of the second message, not performing the cell reselection indication according to the first cell reselection criteria, the cell reselection method process illustrated in the steps 1401 and 1402 may further include the following step E1:
Step E1: performing the cell reselection based on the first priority included in the second message, and the second cell reselection criteria.

wherein the first priority indicates the priority of the frequency used by the first cell.

The first priority indicates that the priority of the frequency used by the first cell is adjusted to the first priority; optionally, the first priority is the highest priority. For example, the first priority may be a priority after dynamically adjusting the priority of the frequency used by the first cell. For example, the migrating node adjusts the priority of the frequency used by the first cell based on a dynamic adjustment strategy. In addition, the first priority may be configured based on demand, for example, the first priority may be the highest priority, the second highest priority, etc., which is not specifically limited in the present disclosure. Wherein, the execution of the method of the step E1 has no limitation on the frequency priority between the first cell and the neighbor cell, i.e., the above case 1, case 2 or case 3, all of which may execute the step E1. For example, the second cell reselection criteria is an existing reselection criteria. In this step, the migrating node dynamically adjusts the priority of the frequency used by the first cell in order to make the UE camp on the first cell as much as possible to avoid delay and power consumption problems.

In yet another possible implementation, a judgment threshold in the second cell reselection criteria may be readjusted to perform the cell reselection in conjunction with the first offset value in the second message. Exemplarily, if the indication based on the second message is not according to the first cell reselection criteria, the cell reselection method process illustrated in the step 1401 and 1402 may further include the following step E2:
step E2: performing a cell reselection based on the first offset value included in the second message, and the second cell reselection criteria;

wherein the first offset value is configured to adjust the judgment threshold in the second cell reselection criteria.

Exemplarily, the UE may modify a first judgment threshold in the second cell reselection criteria based on the first offset value to obtain a second judgment threshold; the UE performs the cell reselection based on the RSRP value of the measurement cell, the second judgment threshold and in combination with the second cell reselection criteria. Wherein, the first offset value may be configured based on demand, and the present disclosure does not specifically limit this. In each of the above cases 1, 2 or 3, the cell reselection may be performed in combination with the adjustment of the judgment threshold in the second cell reselection criteria based on the first offset value. For example, for case 3, the eighth threshold may be adjusted to the ninth threshold, i.e., if the priority of the frequency used by the first cell is lower than the priority of the frequency used by the neighbor cell; the RSRP value of the neighbor cell at the third predetermined time measurement is greater than the ninth threshold, the UE performs the cell reselection. The ninth threshold may be the sum of the first offset value and the eighth threshold, the ninth threshold is greater than the eighth threshold. By adding a new offset value to the second cell reselection criteria, it increases the difficulty for the UE to reselect to other neighbor cell, allowing the UE to camp on the first cell as much as possible to avoid latency and power consumption problems.

In yet another possible implementation, the second message may further include at least one of the sixth, seventh, or eighth indication information, and the migrating node may use the indication information in the second message to indicate the initiation of the UE to the first cell reselection criteria, exemplarily, the step 1402 may include the following steps F1 to F3:
Step F1: if the second message includes the sixth indication information, performing a cell reselection according to the first cell reselection criteria;
Step F2: if the second message includes the seventh indication information or does not include the sixth indication information or does not include the eighth indication information, not according to the first cell reselection criteria;
Step F3: if the second message includes the eighth indication information, performing the cell reselection according to the criteria specified in the first cell reselection criteria.

For either of the first cell reselection criteria, further enhancements may be made in the RRC release. For example, the migrating node adds the sixth indication information or the seventh indication information or the eighth indication information to the second message, such as the RRC release. Wherein, the specified criteria may include at least one of the criteria specified in the first cell reselection criteria. The specified criteria may be set based on demand and is not limited by the present disclosure.

Exemplarily, the migrating node or source donor node may add the sixth indication information or the seventh indication information or the eighth indication information to the downlink message if the third condition information is satisfied; wherein the third condition information may include at least one of the following:
the migrating nodes are moving;
the condition given by the migrating node or source donor node through the implementation.

Wherein if the migrating node is moving, the migrating node may add the sixth indication information to the downlink message, generate the second message, and transmit the second message to the UE to enable the UE to perform the cell reselection according to the sixth indication information or the seventh indication information or the eighth indication information, according or not according to or specifically according to which criteria, etc., such that the migrating node may flexibly control whether the UE performs the cell reselection, this helps the UE to camp on the first cell as much as possible to avoid the delay and power consumption problems caused by the inability to find a suitable cell.

The cell reselection method provided in the embodiment of the present disclosure, by obtaining the second message transmitted by the migrating node which the UE served by; based on the second message, the cell reselection is performed according to the first cell reselection criteria, which may effectively avoid reselection to the wrong cell, avoid frequent cell selection by the UE because it cannot find a suitable cell, and then avoid problems such as delay and power consumption that may be caused by frequent cell reselection, and effectively improve the UE communication service quality.

Moreover, especially when the mobile IAB node is supported in the future, for the UE served by the migrating node with mobility attributes, such as the UE in the idle state, it may make the UE camp on the first cell as much as possible without measurement based on the frequency and priority of the neighbor cell, avoiding the situation that the UE cannot camp on the first cell and the UE cannot reselect to the appropriate cell, thus avoiding cases where the UE cannot camp on the first cell and the UE cannot reselect to a suitable cell, thus further avoiding the latency and power consumption problems caused by frequent reselection in these cases.

Embodiments of the present disclosure provide a source donor node. The source donor node includes:
a first transmitting module for transmitting first information to a user equipment (UE), the first information being configured to assist a source donor node in UE context handover.
a second transmitting module for transmitting a handover command to the UE.

In some optional embodiments, the source donor node includes:
a third transmitting module for transmitting first condition information or a handover command carrying the first condition information to the user equipment (UE);
or,
a fourth transmitting module for transmitting a handover command carrying the second condition information to a migrating node which the UE served by;
wherein, the first condition information is configured to indicate a condition to be satisfied for the UE to perform context handover, and the second condition information is configured to indicate a condition to be satisfied for the migrating node to transmit the handover command to the UE.

Embodiments of the present disclosure provide a user equipment (UE). The user equipment (UE) includes:
a first receiving module for receiving first information transmitted by a source donor node, the first information being configured to assist the source donor node in UE context handover;
a second receiving module for receiving the handover commands transmitted by the source donor node.

In some optional embodiments, the UE is used to:
a third receiving module for receiving first condition information or a handover command carrying the first condition information transmitted by the source donor node;
or,
a fourth receiving module for receiving a handover command carrying the second condition information transmitted by the migrating node which the UE served by;
wherein, the first condition information is configured to indicate the condition to be satisfied for the UE to perform the context handover, and the second condition information is configured to indicate the condition to be satisfied for the migrating node to transmit the handover command to the UE.

In some optional embodiments, the UE is used to:
a fifth receiving module for receiving a second message transmitted by the migrating node which the UE served by;
a cell reselection module for performing a cell reselection based on the second message, according to the first cell reselection criteria;
wherein the UE camps on the first cell and the cells included in the migrating node include the first cell.

Embodiments of the present disclosure provide a migrating node. The migrating node includes:
a sixth receiving module for receiving a handover command carrying second condition information transmitted by the source donor node;
a fifth transmitting module for transmitting a handover command to the UE if the migrating node satisfies the second condition information;
wherein, the second condition information is configured to indicate a condition to be satisfied for the migrating node to transmit the handover command to the UE.

The device of the embodiment of the present disclosure may perform the device provided in the embodiment of the present disclosure with similar implementation principles. The actions performed by each module in the device of each embodiment of the present disclosure are corresponding to the steps in the device of each embodiment of the present disclosure, and the detailed functional description of each module of the device may be specifically referred to the description in the corresponding device shown in the previous section and will not be repeated here.

An electronic device is provided in the embodiment of the present disclosure includes:
a transceiver for receiving and transmitting signals;
a controller, coupled to the transceiver and configured to perform control to implement the steps of each of the preceding method embodiments.

Optionally, the electronic device may be a source donor node, and the processor in the electronic device is configured to perform control to implement the steps of transmitting a handover command as provided in the preceding method embodiments.

Optionally, the electronic device may be a UE, the processor in the electronic device being configured to perform controls to implement the steps of the method for transmitting a handover command or the cell reselection method provided in each of the preceding method embodiments.

Optionally, the electronic device may be a migrating node which the UE served by, and the processor in the electronic device is configured to perform controls to implement the steps of transmitting handover command provided in the preceding method embodiments.

In an optional embodiment, a computer device is provided, as shown in FIG. 15, wherein the computer device 1500 shown in FIG. 15 includes: a processor 1501 and a memory 1503, wherein the processor 1501 and the memory 1503 are connected, e.g., via a bus 1502. Optionally, the computer device 1500 may also include a transceiver 1504, which may be used for data interactions between the computer device and other computer devices, such as the transmission of data and/or the reception of data, etc. It should be noted that the transceiver 1504 is not limited to one in practical applications, and the structure of the computer device 1500 does not constitute a limitation of the embodiment of the present disclosure.

The processor 1501 may be a CPU (Central Processing Unit), a general-purpose processor, a DSP (Digital Signal Processor), an ASIC (Application Specific Integrated Circuit), an FPGA (Field Programmable Gate Array), or any combination thereof. Integrated Circuit), FPGA (Field Programmable Gate Array), or other programmable logic device, transistor logic device, hardware component, or any combination thereof. It may implement or execute various exemplary logic boxes, modules, and circuits described in conjunction with the disclosure of the present disclosure. The processor 1501 may also be a combination that implements a computing function, such as a combination containing one or more microprocessors, a combination of a DSP and a microprocessor, etc.

The bus 1502 may include a pathway to transfer information among the above components. The bus 1502 may be a PCI (Peripheral Component Interconnect) bus or an EISA (Extended Industry Standard Architecture) bus, for example. The bus 1502 may be divided into address bus, data bus, control bus, etc. For the convenience of representation, only a thick line is used in FIG. 15, but it does not mean that there is only one bus or one type of bus.

The memory 1503 may be ROM (Read Only Memory) or other types of static storage devices that may store static information and instructions, RAM (Random Access Memory) or other types of dynamic storage devices that may store information and instructions, or EEPROM (Electrically Erasable Programmable Read Only Memory), CD-ROM (Compact Disc Read Only Memory) or other optical disc storage, optical disc storage (including compact discs, laser discs, CD-ROMs, Digital Versatile Discs, Blu-ray Discs, etc.), disk storage media\other magnetic storage devices, or any other media capable of being configured to carry or store computer programs and capable of being read by a computer, without limitation here.

The memory 1503 is configured to store a computer program for executing an embodiment of the present disclosure and is controlled for execution by processor 1501. The processor 1501 is configured to execute the computer program stored in the memory 1503 to implement the steps shown in the preceding method embodiment.

Embodiments of the present disclosure also provide a source donor node includes:
a transceiver for receiving and transmitting signals;
a controller, coupled to the transceiver and configured to perform the method for transmitting a handover command.

Embodiments of the present disclosure also provide a migrating node which a user equipment (UE) served by includes:
a transceiver for receiving and transmitting signals;
a controller, coupled to the transceiver and configured to perform the method for transmitting a handover command.

Embodiments of the present disclosure also provide a user equipment (UE) includes:
a transceiver for receiving and transmitting signals.
a controller, coupled to the transceiver and configured to perform a method for transmitting a handover command or a cell reselection method.

Embodiments of the present disclosure provide a computer-readable storage medium on which a computer program is stored, and the computer program, when executed by a processor, implements the steps and corresponding contents of the foregoing method embodiments.

Embodiments of the present disclosure also provide a computer program product including a computer program, the computer program being executable by a processor to implement the steps and corresponding contents of the foregoing method embodiments.

It will be understood by those skilled in the art that, unless specifically stated, the singular forms “one”, “a”, “said” and “the” as used herein may also include the plural form. The terms “include” and “comprise” as used in the embodiments of the present disclosure mean that the corresponding features may be implemented as the features, information, data, steps, operations presented, but do not exclude the implementation of other features, information, data, steps, operations, etc. supported in the art.

The terms “first”, “second”, “third”, “fourth”, “1”, “2”, etc., in the specification and claims of the present disclosure and the accompanying drawings above, if present, are configured to distinguish similar objects and need not be configured to describe a particular order or sequence. It should be understood that the data so used may be interchangeable where appropriate so that embodiments of the present disclosure described herein may be implemented in an order other than that illustrated or described in the text.

It should be understood that although the flow diagrams of embodiment of the present disclosure indicate the individual operational steps by means of arrows, the order in which these steps are carried out is not limited to the order indicated by the arrows. Unless explicitly stated herein, in some implementation scenarios of embodiments of the present disclosure, the implementation steps in the respective flowcharts may be performed in other orders as desired. In addition, some or all of the steps in each flowchart may include multiple sub-steps or multiple stages based on the actual implementation scenario. Some or all of these sub-steps or phases may be executed at the same moment, and each of these sub-steps or phases may also be executed separately at different moments. The execution order of these sub-steps or stages may be flexibly configured according to requirements in scenarios where the execution time is different, and this is not limited by the embodiments of the present disclosure.

It should be noted that for a person of ordinary skill in the art, other similar means of implementation based on the technical ideas of the present disclosure, without departing from the technical concept of the present disclosure, also fall within the scope of protection of the embodiments of the present disclosure.

1-15. (canceled)

16. A method performed by a user equipment (UE) in a wireless communication system, comprising:
transmitting first assistance information to a second node, wherein the first assistance information comprises a traffic period of the UE;
receiving a second message, which includes information regarding cell, from the second node, wherein the information regarding cell is configured to indicate a UE to perform cell reselection according to a first priority of a frequency used by a first cell; and
performing the cell reselection, based on the information regarding cell.

17. The method of claim 16, further comprising:
transmitting a first message to the second node based on the first assistance information; and
receiving, based on the first message, a handover command from the second node.

18. The method of claim 16, wherein the first assistance information comprises at least one of following items:
a time at which the UE expects context handover; or
a time period during which the UE expects context handover.

19. The method of claim 16, further comprising:
receiving a first message including first information from the second node; and
receiving a handover command from the second node,
wherein the first information is configured to assist the second node in UE context handover.

20. The method of claim 19, wherein the first information comprises at least one of following items:
a first inquiry message, the first inquiry message being configured to inquire the UE for information relating to a time at which the UE expects context handover; or
first information regarding cell, the first information regarding cell being configured to indicate information relating to at least one time period for the context handover, and
wherein the first message comprises at least one of following items:
second information, the second information being configured to indicate information relating to a time at which the UE expects context handover; or third information, the third information being configured to indicate information relating to a target time period selected by the UE from at least one time period.

21. The method of claim 19, wherein the first information comprises a time at which the second node performs the UE context handover.

22. The method of claim 16, further comprising:
receiving, from the second node, grouping information based on the first assistance information, the grouping information being configured to indicate a group which the UE belongs to;
receiving second information regarding cell corresponding to a group for which context handover is to be performed; and
receiving a handover command corresponding to the group for which context handover is to be performed,
wherein the second information regarding cell is configured to indicate that each UE included in the group receives the handover command.

23. The method of claim 22, wherein the second information regarding cell comprises at least one of following items:
a notification message, the notification message being configured to notify each UE included in the group to perform the context handover;
a time-frequency resource to be used by each UE included in the group to receive a handover command; or
a group identifier of the group.

24. A user equipment (UE) in a communication system, the UE comprising:
a transceiver; and
a controller configured to:
transmit first assistance information to a second node, wherein the first assistance information comprises a traffic period of the UE;
receive a second message, which includes information regarding cell, from the second node, wherein the information regarding cell is configured to indicate a UE to perform cell reselection according to a first priority of a frequency used by a first cell; and
perform the cell reselection, based on the information regarding cell.

25. The UE of claim 24, wherein the controller is further configured to:
transmit a first message transmitted to the second node based on the first assistance information; and
receive, based on the first message, a handover command from the second node.

26. A method performed by a second node in a wireless communication system, comprising:
receiving, from a user equipment (UE), first assistance information, wherein the first assistance information comprises a traffic period of the UE; and
transmitting, to the UE, a second message, which includes information regarding cell, wherein the information regarding cell is configured to indicate a UE to perform cell reselection according to a first priority of a frequency used by a first cell.

27. The method of claim 26, further comprising:
receiving, from the UE, a first message based on the first assistance information; and
transmitting, to the UE, a handover command based on the first message.

28. The method of claim 26, wherein the first assistance information comprises at least one of following items:
a time at which the UE expects context handover; or
a time period during which the UE expects context handover.

29. The method of claim 26, further comprising:
transmitting, to the UE, a first message including first information; and
transmitting, to the UE, a handover command,
wherein the first information is configured to assist the second node in UE context handover.

30. The method of claim 29,
wherein, the first information comprises at least one of the following items:
a first inquiry message, the first inquiry message being configured to inquire the UE for information relating to a time at which the UE expects context handover; or
first information regarding cell, the first information regarding cell being configured to indicate information relating to at least one time period for the context handover, and
wherein the first message comprises at least one of the following items:
second information, the second information being configured to indicate information relating to a time at which the UE expects context handover; or
third information, the third information being configured to indicate information relating to a target time period selected by the UE from the at least one time period.

31. The method of claim 29, wherein the first information comprises a time at which the second node performs the UE context handover.

32. The method of claim 26, further comprising:
transmitting, to the UE, grouping information based on the first assistance information, the grouping information being configured to indicate a group which the UE belongs to;
transmitting, to the UE, second information regarding cell corresponding to a group for which context handover is to be performed; and
transmitting, to the UE, a handover command corresponding to the group for which context handover is to be performed,
wherein, the second information regarding cell is configured to indicate that each UE included in the group receives the handover command.

33. The method of claim 32, wherein, the second information regarding cell comprises at least one of the following items:
a notification message, the notification message being configured to notify each UE included in the corresponding group to perform the context handover;
a time-frequency resource to be used by each UE included in the corresponding group to receive a handover command; or
a group identifier of the corresponding group.

34. A second node in a communication system, the second node comprising:
a transceiver; and
a controller configured to:
receiving, from a user equipment (UE), first assistance information, wherein the first assistance information comprises a traffic period of the UE; and
transmitting, to the UE, a second message, which includes information regarding cell, wherein the information regarding cell is configured to indicate a UE to perform cell reselection according to a first priority of a frequency used by a first cell.

35. The second node of claim 34, wherein the controller is further configured to:
receive, from the UE, a first message based on the first assistance information; and
transmit, to the UE, a handover command based on the first message.
